(19) United States
(12) Patent Application Publication
(10) Pub. No.: US 2006/0064411 A1
(43) Pub. Date: Mar. 23, 2006

(54) Search engine using user intent

(76) Inventors: William Gross, Pasadena, CA (US); Thomas McGovern, Pasadena, CA (US); Reed Sturtevant, Lexington, MA (US)

Correspondence Address: CHRISTIE, PARKER & HALE, LLP, PO BOX 7068, PASADENA, CA, 91109-7068, US

(21) Appl. No.: 11/234,769

(22) Filed: Sep. 22, 2005

Related U.S. Application Data
(60) Provisional application No. 60/612,619, filed on Sep. 22, 2004.
(60) Provisional application No. 60/616,044, filed on Oct. 4, 2004.

(51) Int. Cl. G06F 17/30

(52) U.S. Cl. 707/3

(57) ABSTRACT

A system and method for ranking search results based on a series of attributes derived from the behavior of past searchers is disclosed. The attributes provide a measure of the relevancy between a search query and a URL, file, or other resource based on its relevancy to prior users. The system comprises (1) an attribute database including a plurality of prior search terms or phases; a first set of resources associated with each of the queries; and the attributes, i.e., metrics, characterizing the relevance of the first set of resources to the queries; and (2) a search processor adapted to identify a second set of resources determined to be relevant to a user query; rank each of the second set of resources based on the metrics associated with the query and resource; and provide the user with the search results ranked in accordance the metrics and displayed in a manner to increase the utility of the results for the user.

### CROSS-REFERENCE TO RELATED APPLICATION(S)

This application claims the benefit of U.S. Provisional Patent Application Ser. No. 60/612,619 filed Sep. 22, 2004, entitled “Behavioral Search Engine,” and U.S. Ser. No. 60/616,044 filed Oct. 4, 2004, entitled “Search Results based on Search User Intent,” which are hereby incorporated by reference herein for all purposes.

### COPYRIGHT RIGHTS

A portion of the disclosure of this patent document contains material that is subject to copyright protection. The copyright owners have no objection to the facsimile reproduction by any one of the patent document or the patent disclosure, as it appears in the Patent and Trademark Office patent file or records, but otherwise reserve all copyright rights whatsoever.

### FIELD OF THE INVENTION

This invention relates to search engines, particularly, to a search engine that collects the search behavior of past searchers and presents search results based on the intent of the user determined in part from the behavior of the past searchers.

### BACKGROUND

There are many Internet search engines capable of searching computer networks for documents of interest, and generating listings of search results based on the documents identified in the search. Search engines often generate search results that include hyperlinks to underlying documents, thereby allowing a person browsing the search results to connect to, and view, a document of interest directly from the search results. Search results also typically includes text that is descriptive of the underlying documents identified in the search. Such descriptive text, which is displayed as a portion of the result of a query, is generated in an automated process by a processor that crawls the World Wide Web (WWW) to locate webpages, inspects the content of the identified webpages, and generates an index associating the content of the inspected webpages with the uniform resource identifier (URL) of the inspected webpages.

When the search engine is queried by a user, the search engine generally matches the query terms with those terms indexed to generate a list of URLs to those webpages that are relevant to the user's query. The search results presented to users are typically matched with the query terms based on the words contained in webpages and other factors including hyperlink analysis. The search results are generally also ranked based on these factors and presented to the user beginning with the most relevant search results.

Although traditional search engines use well-established information retrieval practices of identifying matches of search terms to words in documents, they do not consider the likely intent of the search user in the process of resource retrieval r. If a user submits a search query for the term “rocker” for example, a conventional search engine cannot distinguish whether the typical user intended to view results related to musicians, automobile parts, or furniture. The webpages that are relevant to each of these categories are generally different and can significantly influence the quality of the user's experience with the search engine. There is therefore a need for a search engine capable of discerning the typical user's intent and selecting and ranking search results most relevant to the user.

### SUMMARY

The preferred embodiment of the present invention features a system and method for ranking search results based on the behavior of past searchers as represented by a series of attributes, each of which provides a measure of the relevancy between a search query and a URL, contents of a file, or other resource. The system in the preferred embodiment comprises at least an attribute database and a search processor. The attribute database generally comprises a plurality of queries, i.e., prior search terms and phases; a first set of resources associated with each of the queries, and a set of one or more metrics characterizing the relevance of the first set of resources to the plurality of queries. The set of one or more metrics are derived from post-search user behavior of a plurality of prior users, i.e., prior searchers. The plurality of queries are generally searches that were conducted by the prior users, and the first set of resources are generally websites that were viewed by the prior users subsequent to those searches.

The search processor is a computing device such as a server adapted to receive a query from a user via the Internet, for example; identify a second set of resources relevant to the received query; retrieve from the attribute database the one or more metrics associated with the received query and each of the second set of resources by matching the received query to a previous query and matching the URLs of the second set of resources with the resources recited in the first set of resources; rank each of the second set of resources based on the retrieved metrics; and return at least a portion of the second set of resources ranked in accordance the retrieved one or more metrics. The present users are therefore generally provided more relevant search results because those results are ranked in a manner that increases the relative placement of those URLs determined to be most relevant by prior users executing the same, or similar, query.

The set of metrics that may be extracted from the post-search user behavior of a plurality of prior users and incorporated into the attribute database generally includes: the average number of prior user click-throughs from a search result page to the associated URL; the frequency with which the prior users viewed the associated URL; the number of webpages at a domain associated with the URL, the average number of webpages viewed by the prior users at the domain associated with the URL; the average time spent by prior users viewing webpages at the domain associated with the URL; the average number of prior users that downloaded files from the domain associated with the URL; the average number of prior users that executed scripts from the domain associated with the URL; the average number of prior users that placed orders at the domain associated with the URL; the average number of prior users that made purchases at the domain associated with the URL; and the average number of sessions created by prior users. The set of metrics may also include the URL character length, i.e., the number of characters in the resource locator or identifier; the URL number count, i.e., the number of numeric characters in the resource locator or identifier; the URL hyphen count, i.e., the number of hyphens in the resource locator or identifier; the top level domain type, and country domain.

In the preferred embodiment, the post-search user behavior of the prior users is derived from the clickstreams of each of the prior users, which may be recorded in surf history logs by one or more Internet service providers, one or more user computers, one or more intermediate nodes including, for example, a proxy server or firewall in a local area network (LAN). In some embodiments, the source of the clickstream data of prior searchers may be constrained to specific user segment, such as a user psychographic profile, such that the resulting metrics used by the invention will provide greater relevance to future users who are members of the same, or similar, user segment or parties interested in search results for that segment.

The second set of resources are generally derived from an algorithmic search index created by a Web crawler, for example, although the attribute database may also provide a source of relevant URLs that may or may have been discovered by the crawler. Although the second set of resources may be ranked using traditional information retrieval techniques, the search processor re-ranks the search results using any of a number of statistical methods including linear and non-linear algorithms such as linear or exponential least squares fit, for example, that weights the various metrics in a manner that best matches an ideal ranking defined by a human editor.

Some embodiments of the system of the present invention further comprise a display processor adapted to: select one of a plurality of page display types based at least in part on the received query; and generate a search result page with ranked search results formatted in accordance with the selected page display type. The plurality of page display types comprises at least a navigation page type, a cluster page type, a product page type, and a general page type used when none of the preceding displays types is applicable.

### BRIEF DESCRIPTION OF THE DRAWINGS

The present invention is illustrated by way of example and not limitation in the figures of the accompanying drawings, and in which:

FIG. 1A is high-level system architecture of a search portal system, according to a preferred embodiment of the invention;

FIGS. 1B and 1C are more detailed functional block diagrams of exemplary portal managers, according to embodiments of the present invention;

FIG. 1D is a functional block diagram of an exemplary network performing the searching features according to an embodiment of the invention;

FIG. 2A is a functional block diagram of an exemplary ISP user communicating with an ISP, according to an embodiment of the invention;

FIG. 2B is an exemplary surf history log, according to an embodiment of the invention;

FIG. 2C is an example of a uniform resource locator address showing its various components according to an embodiment of the invention;

FIG. 3 is a table illustrating an exemplary ISP history log according to an embodiment of the invention;

FIG. 4 is a diagram, including a display table, illustrating an exemplary user history log generated at the client or user side in accordance with the present invention;

FIG. 5 is a functional block diagram of a surf behavior attribute database and a log processor, according to an embodiment of the invention;

FIG. 6 is a display table illustrating an exemplary client-side history log, according to an embodiment of the invention;

FIG. 7 is an comprehensive SB attribute database compiled by the log processor, according to an embodiment of the invention;

FIG. 8 is an comprehensive SB attribute database with order metrics, according to an embodiment of the invention;

FIG. 9 is a diagram showing how a search results page is generated, according to an embodiment of the invention;

FIG. 10 is a functional block diagram of an exemplary network performing the searching features and display type selection, according to an embodiment of the invention;

FIGS. 11A and 11B illustrate a high-level flowchart showing how display types are selected and their corresponding webpages generated, according to an embodiment of the present invention;

FIG. 12 is an exemplary general search result page, which includes the search results ranked in accordance with exemplary sorting steps of the present invention;

FIG. 13 is an exemplary navigation search results page, according to an embodiment of the present invention;

FIG. 14 is an exemplary clustered search results page, according to an embodiment of the present invention; and

FIGS. 15-17 are exemplary product search result pages, according to embodiments of the present invention.

### DESCRIPTION OF THE PREFERRED EMBODIMENT

A preferred embodiment of the present invention operates on the Internet, and more specifically, on the World Wide Web. The World Wide Web is based on, among other protocols, the Hypertext Transfer Protocol (HTTP), which uses a general connection-oriented protocol such as the Transmission Control Protocol/Internet Protocol (TCP/IP). However, the present invention is not limited to HTTP, nor to its use of TCP/IP or any other particular network architecture, software or hardware which may be described herein. The principles of the invention apply to other communications protocols, network architectures, hardware and software which may come to compete with or even supplant the state of the art at the time of the invention.

Throughout the following description, the term “website” is used to refer to a collection of content. Website content is often transmitted to users via one or more servers that implements the basic World Wide Web standards for the coding and transmission of HTML documents. It will be understood to one skilled in the art that the term “website” is not intended to imply a single geographic or physical location but also includes multiple geographically distributed servers that are interconnected via one or more communications systems.

Furthermore, while the following description relates to an embodiment utilizing the Internet and related protocols, other networks or hypermedia databases, such as networked interactive televisions, and other protocols can be used as well. For example, for use with cell phones, personal digital assistants (PDAs), and the like, HDML (Handheld Device Markup Language), WAP (Wireless Application Protocol), WML (wireless markup language), or the like can be used.

Additionally, unless otherwise indicated, the functions described herein are performed by programs including executable code or instructions running on one or more general-purpose computers. The computers can include one or more central processing units for executing program code, volatile memory, such as random access memory (RAM) for temporarily storing data and data structures during program execution, non-volatile memory, such as a hard disc drive or optical drive, for storing programs and data, including databases, and a network interface for accessing an intranet and/or the Internet. However, the functions described herein can also be implemented using special purpose computers, state machines, and/or hardwired electronic circuits. The example processes described herein do not necessarily have to be performed in the described sequence, and not all states have to be reached or performed.

Further, while the following description may refer to “clicking on” a link or button, or pressing a key to provide a command or make a selection, the commands or selections can also be made using other input techniques, such as using voice input, pen input, mousing or hovering over an input area, and/or the like. In addition, the terms “article”, “item” and “product” can be used interchangeably. As used herein, the term “click-through” is defined broadly, and refers, in addition to its ordinary meaning, to clicking on a hyperlink included within search result listings to view an underlying website.

As used herein, the term “document” is defined broadly, and includes, in addition to its ordinary meaning, and type of content, data or information, including without limitation, the content, data and information contained in computer files and websites. Content stored by servers and/or transmitted via the communications networks and systems described herein may be stored as a single document, a collection of documents, or even a portion of a document. Moreover, the term “document” is not limited to computer files containing text, but also includes computer files containing graphics, audio, video, and other multimedia data. Documents and/or portions of documents may be stored on one ore more servers.

As used herein, the term paid “listing” is defined broadly, and includes, in addition to its ordinary meaning, a unique type of record displayed on a search results page where a sponsor or other party has provided specific information to be displayed as a result to a query of a search engine. Typically, an advertiser has sponsored, or paid, to have specific information and images displayed as a result of a user query. However, advertisers may also pay to be identified by their URLs incorporated into the search engine's index so that such URL's will be considered in determining algorithmic results for presentation to users.

As used herein, the term “listing sponsor” is defined broadly, and includes, in addition to its ordinary meaning, a person or organization sponsoring a document appearing in a search result listing generated by a search engine.

As used herein, the term “algorithmic results” is defined broadly, and includes, in addition to its ordinary meaning, search results based on an index of webpages where a computerized algorithm searches through the index and compiles search results based on relevancy to the query. The index is typically developed through computerized agents that access the World Wide Web through a process known in the art as crawling and spidering.

The user behavior search engine of the preferred embodiment compiles information of prior user search behavior with which the search engine can infer the interests and intent of users, thereby enabling the search engine to present more relevant search results to subsequent users conducting the same or a similar search query. The information compiled in the preferred embodiment is derived from post-search user behavior (PSUB) information acquired from the user subsequent to executing a search at any of a number of search engine websites. The PSUB information may be collected from any of a plurality of sources including a consenting user's computer or the user's Internet Service Provider (ISP). The categories of PSUB information acquired may include search terms that resulted in click-throughs to particular webpages, websites and subdomains visited, the amount of time users view those webpages, and actions taken at the websites including document downloads and financial transactions. PSUB information may be collected from multiple users and aggregated to provide a statistical model from which the search engine can more accurately predict the intent of subsequent users and serve the most relevant search results accordingly.

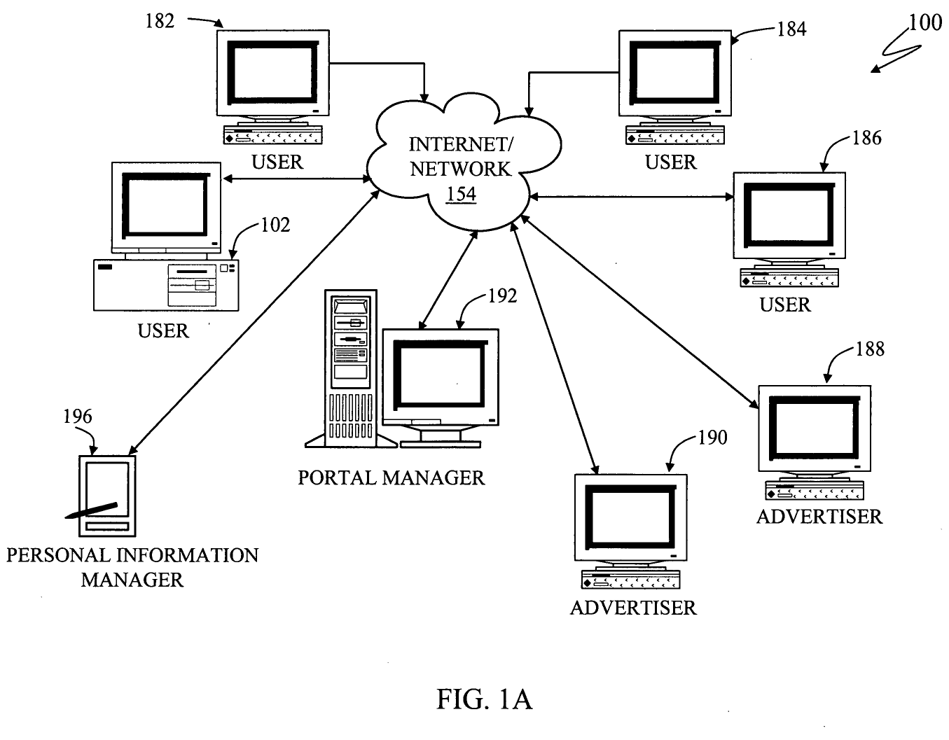

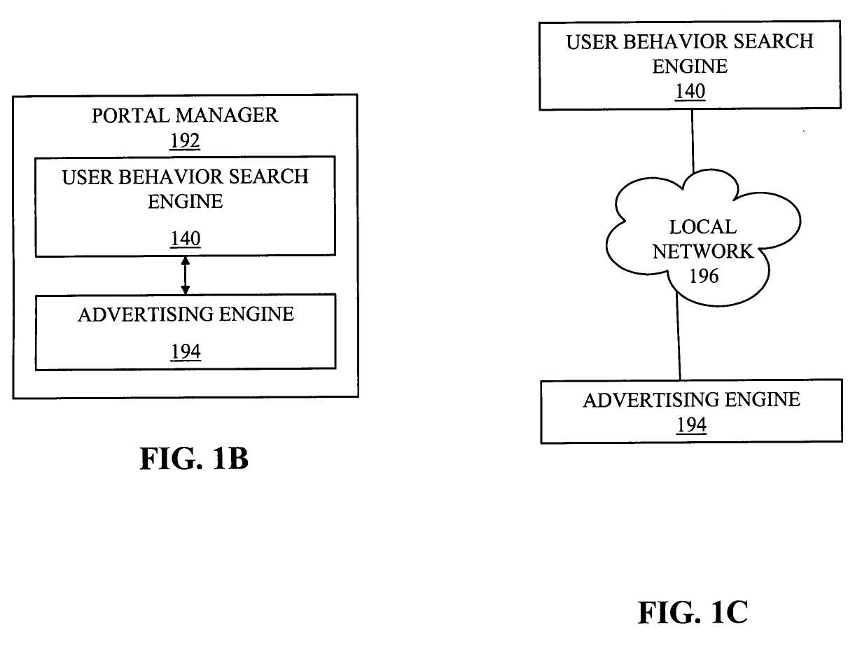

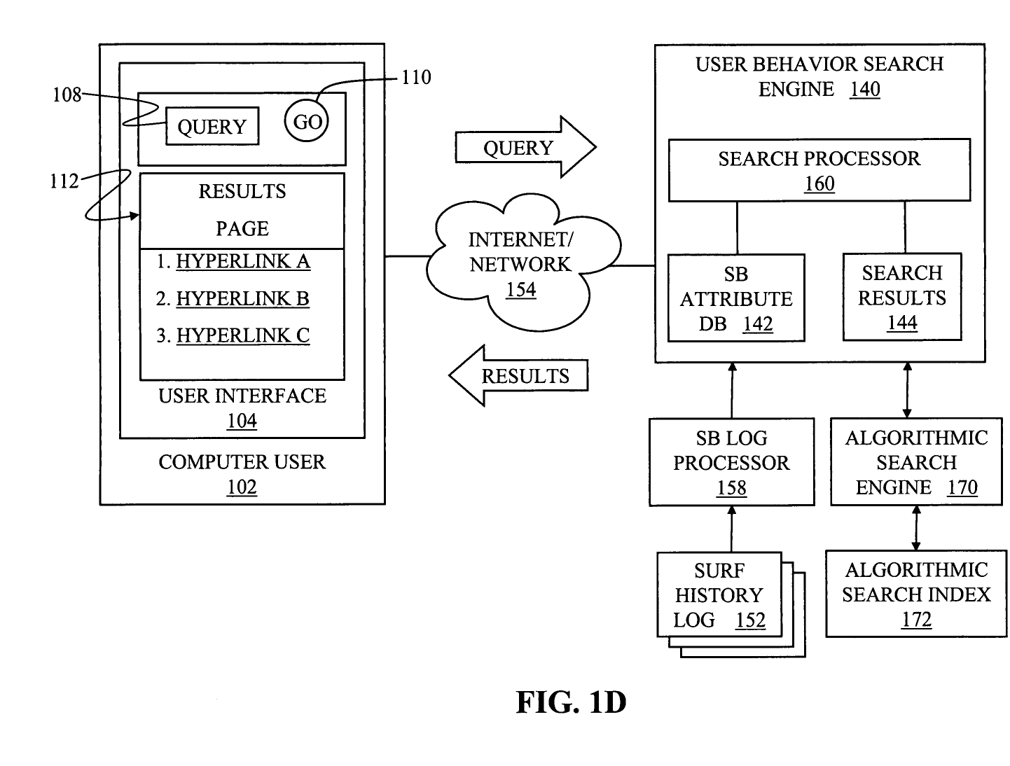

FIG. 1A is high-level system architecture of a search portal system 100, in accordance with a preferred embodiment of the invention. The portal system 100 provides a search engine for users, an advertising venue for advertisers, and a revenue-source for portal system operators. The portal system 100 preferably includes a portal manager 192 that various clients, including search users and advertisers, may access. The portal manager 192 preferably functions as a website and includes one or more servers, comprising both hardware and software, adapted to perform the methods of the present invention. The clients—including users 102, 182, 184, 186, 196 and advertisers 190, 188—preferably communicate with the portal manager 192 via a data communications network 154 including the Internet, for example.

Illustrated in FIGS. 1B and 1C are functional block diagrams of exemplary portal managers 192 in accordance with the preferred embodiment. FIG. 1B shows a portal manager comprising a user behavior (UB) search engine 140 and an advertising engine 194 residing in the same server 192. FIG. 1C illustrates another embodiment of the portal manager in which the advertising engine 194 resides in a server or other computing device operably coupled to the UB search engine 140 by means of a data communications network such as local data network 196. In these two embodiments, web server features are preferably performed by each engine 140, 194, or alternatively by a different web server engine that may reside within or outside the portal manager 192. In general, users requesting the search engine features of the present invention access the UB search engine 140 while the advertisers desiring to advertise within the portal system 100 access the ad engine 194. This is preferably performed by providing the clients, whether users or advertisers, links to different interfaces, e.g., different web pages.

FIG. 1D illustrates a functional block diagram of an exemplary network including a search engine adapted to employ predetermined PSUB information in response to the search queries. This network includes a user with a personal computing system 102 and a network operator, preferably an Internet Service Provider (ISP), through which the user accesses the Internet or other network 154. The user's computer system 102 generally includes a user interface 104, preferably a browser, which is able to communicate with the UB search engine 140 through various Internet protocols such as hypertext transfer protocol (HTTP) and file transfer protocol (FTP) via the data network 154. This user interface preferably works with various browser utilities, including browser add-ins, java applets, MICROSOFT™ ActiveX controls, and scripts. Example browsers include INTERNET EXPLORER™ from MICROSOFT™ and FIREFOX™ from Mozilla.

When conducting a search of the World Wide Web (WWW), the user interface 104 requests a webpage from the UB search engine 140 via the Internet 154. The webpage returned by the UB search engine preferably includes an input box 108 enabling the user to submit a query including one or more query terms. The user then submits the query by, for example, clicking a submission button, herein labeled “GO” 110, via mouse (not shown) or by pressing the “Enter” key of a keyboard (not shown) connected to the user's computing system 102. Upon receipt of the query, the behavior search processor 160 of the UB search engine server 140 retrieves relevant search results from one or more sources, federates the results, and ranks the results using relevancy information derived from one or more traditional search engines as well as the PSUB information collected in the preferred embodiment. The behavior search processor 160 then transmits a webpage page with ranked search results, preferably including the hyperlinks and summary of one or more websites, to the user where it is displayed by the browser 104. In accordance with some embodiments of the invention, the results page 112 and the ordering of the hyperlinks therein reflect the PSUB information compiled by the user behavior search engine 140.

In the preferred embodiment of the invention, the behavior search processor 160 retrieves search results or other identified resources (also known as candidate files) from one or more sources including one or more algorithmic search indexes. An “index” is a form of database that recites a plurality of individual search terms and associates each of the terms with one or more resources, typically URLS or files, that could be relevant to the search term. The uniform resource locator (URL) for each relevant resource, e.g., webpage or document, may then be retrieved from at least one algorithmic search index 172 by querying the index with the one or more query terms. The algorithmic search index 172 may be compiled and maintained by the UB search engine, one or more third-parties, or combination thereof. The search results returned from the index possess an initial relevancy ranking referred to herein as the original rank.

In the preferred embodiment, the initial algorithmic or original rank of the algorithmic search results is reordered by the UB search engine 140 using one or more search behavior attributes retrieved from the surf behavior attribute database 142. The surf behavior attribute database 142 has the form of a multi-dimensional array relating one or more relevancy attributes to each of a plurality of candidate files—including webpages and documents, for example—based on the search terms. The attributes, which are preferably derived from the web surfing habits of prior search users, characterize and quantify the relevance of associated candidate files with respect to a plurality of search terms and queries. The surf behavior attribute database 142 is preferably stored in a database including one or more tables of a relational database management system (RDBMS), although one skilled in the art may employ various types of data repositories including object oriented databases, plain ASCII files, and flat files, for example. In some embodiments, the surf behavior attribute database 142 may also span more than one table and even more than one database. In an alternative embodiment, the database may store the attributes in a manner such that they are related to search user segments. Examples of user segments could include, but is not limited to, users who access the internet with broadband technology, users of a certain psychographic such as suburban double income no kids households, or interests such as model train collectors, or affinity groups such as members of the American Association of Retired Persons.

The surf behavior attribute database 142 is preferably generated by a surf behavior processor 158 using one or more of surf history logs 152. The surf history logs 152 contain information characterizing the actions of previous users of the Internet that have surfed or otherwise accessed Internet information while conducting searches. The actions recorded in the log preferably include webpages viewed, documents viewed or downloaded, files viewed or downloaded, time spent viewing documents, resources accessed, transactions conducted, purchases made, orders placed, sessions created, or a combination thereof, all of which may be determined from user clickstreams including search histories, search trajectories, and other surf histories, for example. In general, the more time spent and actions taken at a website, the more relevant the website is to the user. The frequency and character of the actions recorded in the surf behavior attribute database 142 may therefore provided indicators of popularity of a certain websites or the likelihood that website will satisfy the user interest that prompted the initially query.

In the preferred embodiment, the surf behavior log processor 158 extracts information from the surf history logs 152 to create the attributes of the surf behavior attribute database 142. The surf history log 152 are compiled in the preferred embodiment by an Internet Service Provide (ISP) from one or more consenting customers, compiled by the one or more users at their personal computers, compiled by one or more intermediate nodes—including proxy servers or firewalls in a local area network for example—between a user and its ISP, or a combination thereof. In general, the anonymity of the various users is preserved by aggregating surf behavior information and redacting user identity information. This surf behavior log processor 158 may reside as part of the search engine 140 or may be outside and independent of the search engine. The surf behavior log processor 158, in one embodiment, is a group of software applications or executables that run outside of the web server environment. In another embodiment, the surf history is associated with a user segment such that the data can be appropriately identified in the surf behavior database.

In addition to the algorithmic search index 172, search results or candidate files may be derived from the surf behavior attribute database 142 which contains URLs of relevant websites, identifiers of websites, and/or other candidate documents learned from the surf history logs 152. Although there is conventionally a high degree of overlap between the websites from the surf behavior attribute database 142 and the websites retrieved from the algorithmic search index 144 associated with a particular query, the surf behavior attribute database 142 may be used in some embodiments to supplement the search results 144 derived from the at least one algorithmic search index 172. One skilled in the art will appreciate that the search results from various sources must be federated—a process used to eliminate redundant search results created when integrating overlapping search results lists—before ranking the results provided to the user.

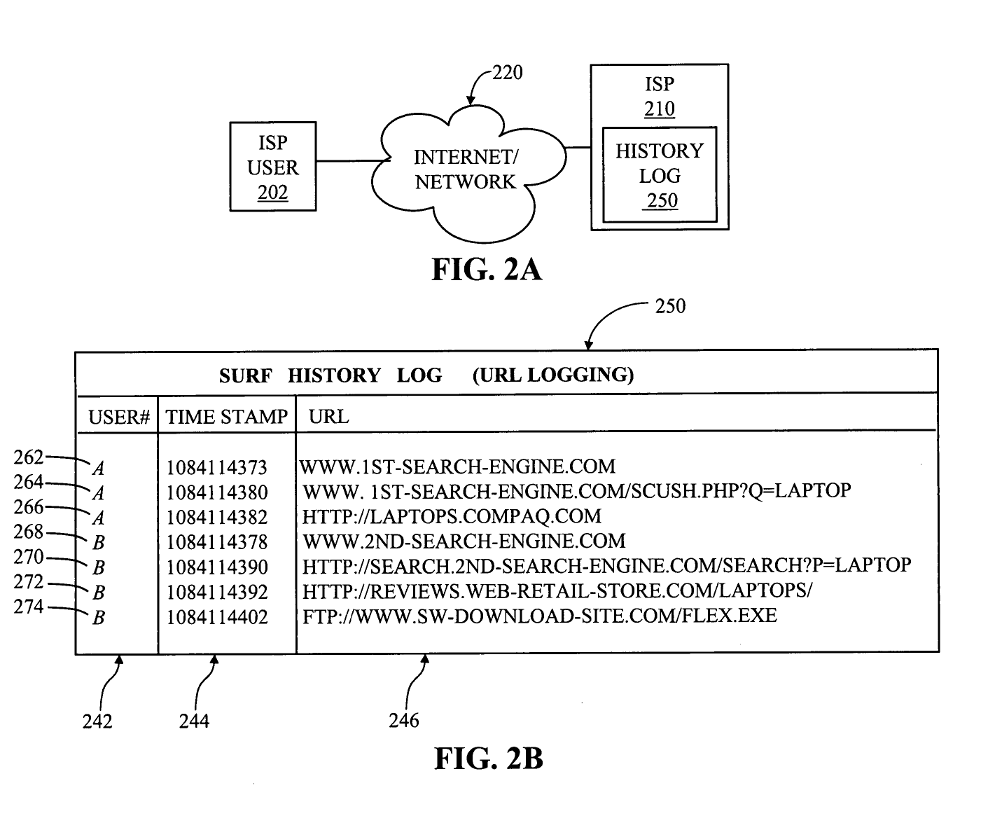

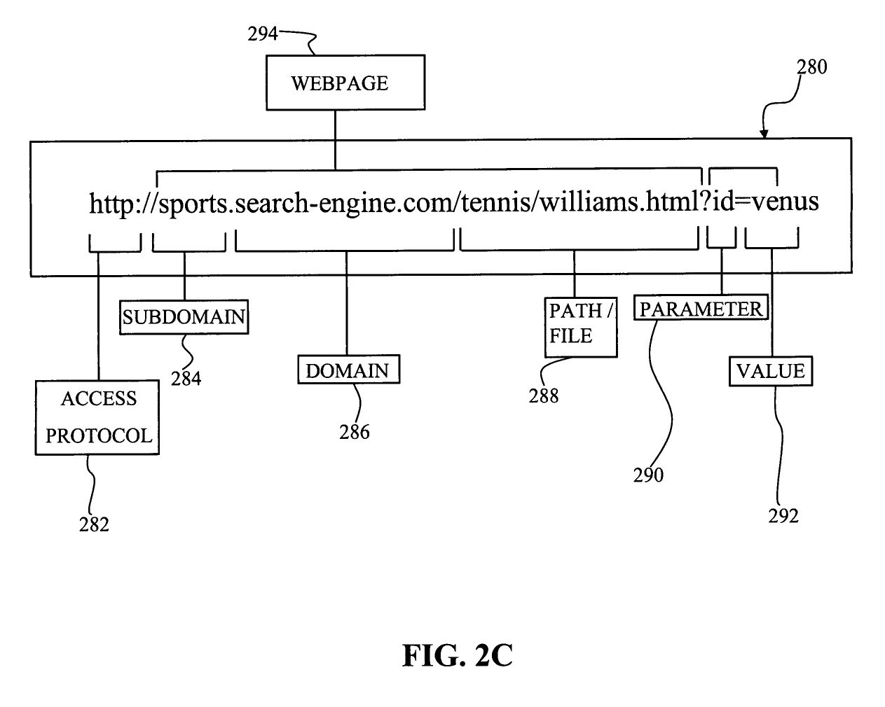

FIG. 2A is a functional block diagram of an exemplary ISP 210 with surf history log 250 typically used by the search processor 160 to generate a results page 112 in response to a search or query, i.e., a search string including one or more key terms or query terms. An ISP, sometimes also referred to as an Internet Access Provider, is generally a company or organization that provides access to the Internet through a dial-up connection, Digital subscriber line (DSL) connection, broadband cable connection, and other wired and wireless links. The customer is typically provided a user name and a password for authentication purposes before being provide access to the Internet. Thereafter, various Internet protocols may be used to access webpages, including HTTP and FTP. A typical HTTP logging configuration, for example, results in a log entry for each HTTP request or hit to the server. Other protocols, such as FTP, may also be used for log entry.

The surf behavior attribute database 142 is preferably created by using one or more history logs compiled by one or more ISPs. In a preferred embodiment, when a user or customer 202 of an ISP accesses the Internet 220, the ISP 210 monitors user transmissions including search engine queries and subsequent actions such as file or document downloads by the customer, scripts executed, and further webpages viewed. The ISP 210 thus records the terms queried by the user as well as the post-search activity of the user. From the post-search activity, post-search user behavior attribute information may be collected for purposes of determining the relevancy of the individual search results.

Illustrated in FIG. 2B is a schematic representation of a surf history log 250 compiled by an ISP for a plurality of users including a first ISP customer A and a second ISP customer B. The search behavior and surf history is arranged or capable of being arranged chronologically for each ISP customer. As illustrated, customer A accessed a search engine, in this example “www.1st-search-engine.com,” in row 262. The next row 264 in the history log shows that customer A initiated a search using the query term “LAPTOP.” After the search was submitted, the search engine of www.1st-search-engine.com returned a search result webpage listing a plurality of webpages (preferably in the form of URLs) related to “LAPTOP.” As shown, customer A then clicked on the “http://laptops.compaq.com” in link 266 to access the associated page. Page requests by client B are shown in the subsequent rows 268, 270, and 272, 274. Client B is illustrated as having downloaded the file/document, “flex.exe,” from the “www.downloadx.com” website as shown in the last row 274 after having conducted the same search at a different website, i.e., www.2nd-search-engine.com shown in line 270.

The post-search user behavior information preferably includes the websites visited by the user and the dwell time, i.e., the time spent viewing those websites. Other information may also be stored as part of the logs 250 including, but not limited to, timestamp 244, a user ID 242, the Internet Protocol (IP) address of the user, make and version of the browser used, and pages viewed 246. The timestamp 244 indicates when the user requested the URL 246. Methods for capturing user ID, user input, webpages accessed, time stamps, IP address, and the actual or approximate dwell time on a particular webpage are known to those of ordinary skill in the art.

Referring to Table I below, the search behavior log processor in some embodiments can discern user's satisfaction from the user's clickstreams by distinguishing preliminary terms queried by the user from the subsequent or final terms queried. A subsequent query is conducted later and generally includes one or more of the initial query terms in addition to one or more terms refining the initial query. The phrase “song lyrics,” for example, would generally be categorized by the behavior search engine as an initial or preliminary query while the phrase “country song lyrics” would be categorized as a subsequent query used to refine the preceding query. If the phrase “country song lyrics” was the last in a series of two or more related searches, it may be presumed that the user was satisfied with the results and at least one of the results that were viewed by the user were significantly relevant to the basis of the search. The final query terms may then be identified using a “terminate” field, which may then be presented to the user as a factor indicating the query is more likely to produce results satisfying the user's interests. One skilled in the art will appreciate that the UB search engine may also attempt to quantify the user's likelihood of reaching “satisfaction” based on one or more metrics extracted from the search behavior logs including, for example, the time spent viewing a webpage, preferably a final webpage, or whether a document was downloaded or a financial transaction conducted.

TABLE I

| | | | TERMINATE |
|---|---|---|---|
| | | | (1 = Yes, |
| TERM | REFINEMENTS | COUNT | 0 = No) |
| SONG | | 1 | |
| LYRICS | | | |
| | COUNTRY | 1 | 1 |
| | SONG LYRICS | | |

The behavioral search engine may also be used to seed an algorithmic search engine, i.e., to identify webpages, documents, and other resources to be crawled and indexed because of their relevancy. As one skilled in the art will appreciate, the behavioral search engine can identify a resource to be crawled based on its correlation with a query, thereby enabling it to discover relevant webpages that would otherwise be invisible to a crawler alone because they are not linked to crawled webpages or are only remotely linked to those crawled pages. Once the relevance of a resource has been identified by the behavioral search engine as being often visited by Internet users, a crawler may be configured to increase the frequency with which the same resource is crawled to ensure that the index is current and fresh as possible.

The behavioral search engine is also particularly well suited to identifying various “opaque resources”—resources whose primary content is graphic data, music data, or other non-text information that are inherently difficult or impossible to crawl and index. For example, the behavioral search engine can associate a picture file with a generic name, e.g., DSC1029.JPG, with the name of the person featured in the photograph by observing user behavior. Moreover, these opaque resources may be indexed locally by the behavioral search engine and their URLs provided in search results depending on their relevancy to the query as determined by a cost function discussed in more detail below.

Referring to FIG. 2C, this exemplary URL 280 shows that a request was made using the HTTP protocol 282. The requested webpage 294 is in the “search-engine.com” domain 286, in “sports” subdomain 284, in path “tennis/williams.html” 288, and that a parameter 290 was submitted with the value of “venus” 292. Various indicators that a query term had been submitted are known in the art, e.g., “?id=” 290. Thus, the query term immediately after the equal sign (“=”), “venus” 292, is identified.

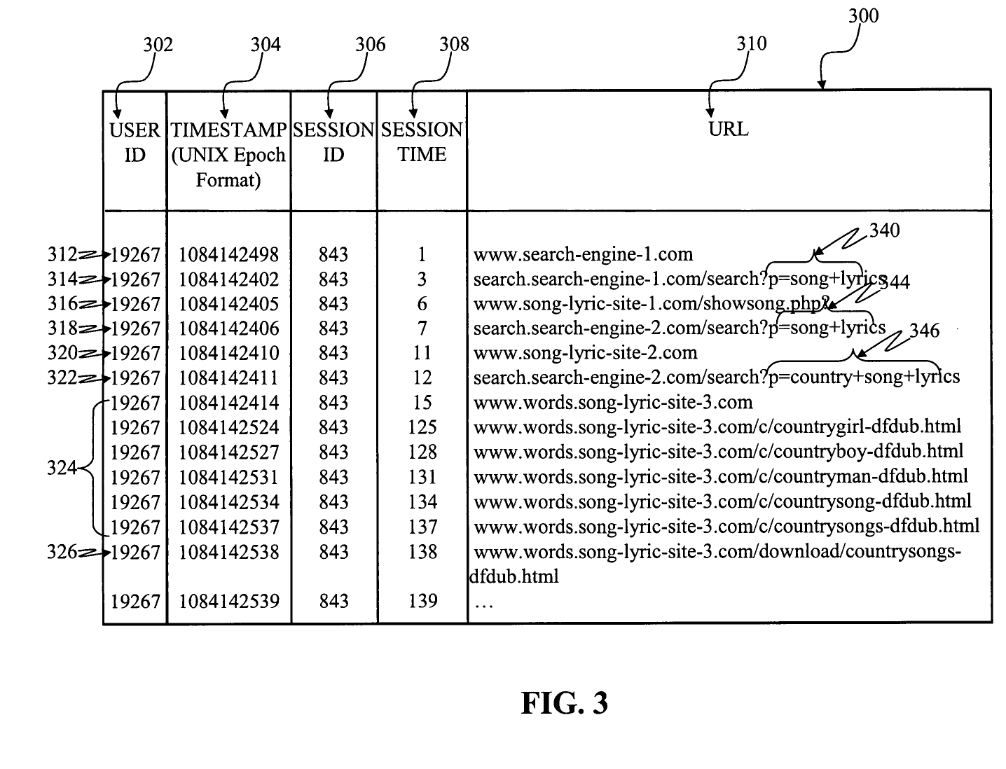

FIG. 3 shows another example of an ISP surf history log 300 and its records in accordance with one exemplary embodiment. This representative portion of an ISP history log is for illustrative purposes only. The log format and types of information collected may vary depending on the particular requirements of the search engine implementation. In this example, the log 300 comprises a plurality of entries, each entry comprising a user ID 302 identifying each client accessing the Internet via the ISP, the time that a particular webpage (URL) 310 is requested as indicated in the “Timestamp” column 304, the session ID identifying the client session as indicated in the “Session ID” column 306, and the session time as indicated in the “Session Time” column 308.

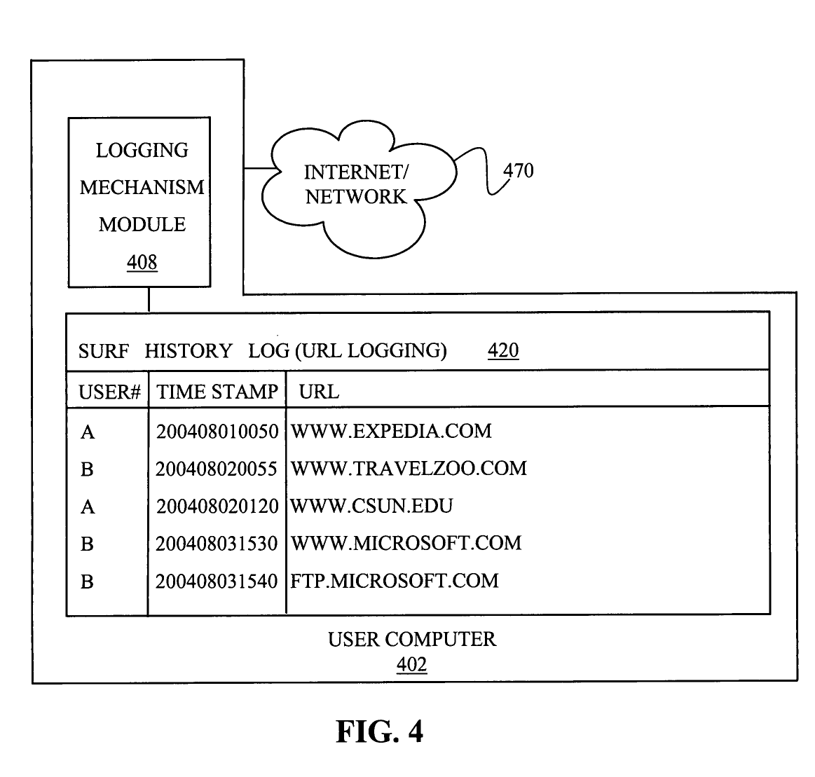

Illustrated in FIG. 4 is a functional block diagram of an example of a system for generating surf history log at a client at a personal computer with Internet access, the generated surf history log being used thereafter by a SB processor in combination with or in place of the ISP history log 300. The personal computer or other computing device includes a logging mechanism module 408, i.e., a computer program, adapted to monitor the search behavior of the user and generate a surf history log 420 residing locally within the user's computer 402. The user's surf history log 420 preferably includes a record of actual queries initiated by the user, the post-search user behavior information, and a timestamp indicating the time of each action. This user log 420 is sent, preferably over the Internet 470, to the search processor 160 or other central server for processing by the surf behavior log processor 158. Where a plurality of users have access to the computer 402, the log 420 may further include a unique identifier associated with each of the users

In an exemplary embodiment, the log 420 is generated on the client side using a logging mechanism module 408 incorporated into the web browser as a add-in or plug-in. The logging module 408 may also be independent of the web browser running as a stand-alone executable program. The logging mechanism module 408 is preferably adapted to automatically generate the surf history log 420 while the user is using the web browser, although module 408 may be activated manually by the user via a toolbar, for example. As with the log from an ISP, the post-search user behavior information retrieved from one or more individual users is aggregated to develop a comprehensive profile of post-search user behavior sufficient to discern user intent and predict the search behavior of future users.

The user's log 420 is generally similar in form and substance to an ISPs URL history log with one or more notable potential differences. First, the user's surf log 420 may include a contiguously record a plurality of user sessions compiled over the course of days or weeks, for example, which may be used by the UB search engine 140 to correlate search queries with post-search behavior over separate user sessions separated by relatively long periods of time. Second, the user's surf log 420 may further include a record distinguishing which of a plurality of users in a household is logged into the computer where supported by user's network operating system. The compilation of post-search user behavior may be compiled and federated at this stage and then sent to the UB search engine 140. In the preferred embodiment, however, the user history logs 420 are sent to the UB search engine 140 for processing by the log processor 158 (FIG. 1). In general, the history logs, whether they are from the ISPs or from users, should preferably be in a location, such as in the search engine 140 server, where the log processor 158 and/or search processor 160 has ready access. Client-side user history logging is preferably initiated by requesting and obtaining a user's permission to capture such data.

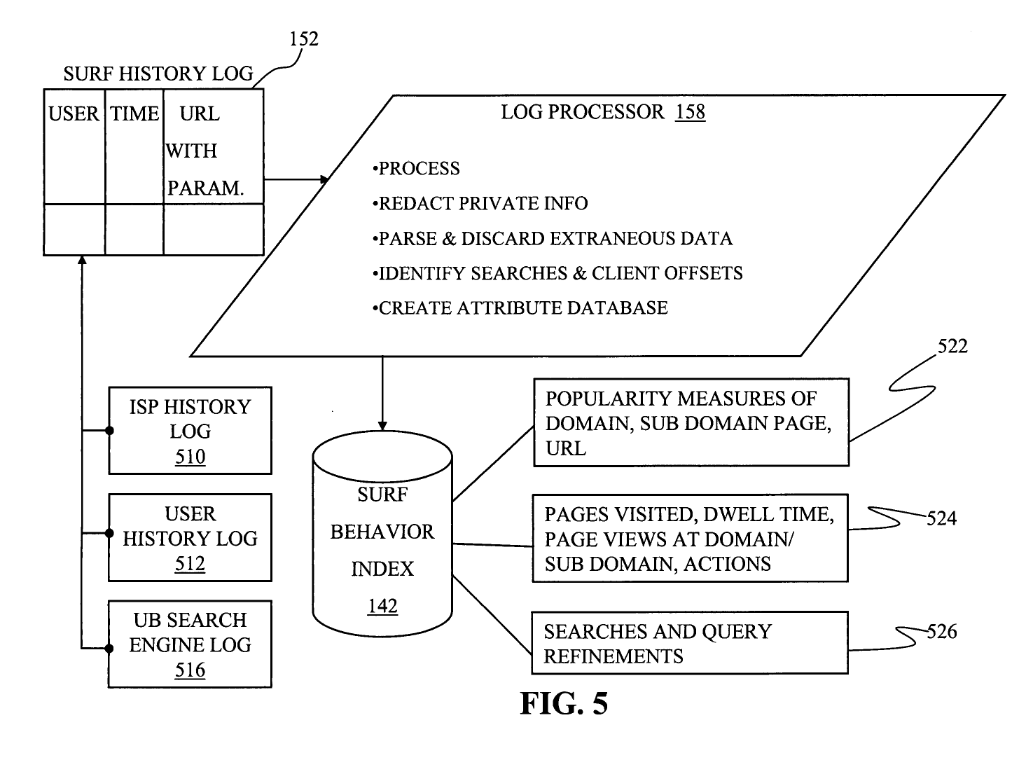

FIG. 5 is a schematic illustration of the surf behavior attribute database 142 processing in accordance with the preferred embodiment. The surf history log 152 is processed by the surf behavior log processor 158 to extract attributes used by the search processor 160 employed to rank or re-rank search results derived from one or more algorithmic search engines, for example. This surf history log 152 may draw information from various logging sources including, for example, an ISP history log 510 (see FIGS. 2B and 3), one or more individual user history logs 512 (see FIG. 4), a history log 516 compiled locally by the UB search engine 140 in this embodiment, one or more firewalls or proxy servers in a user's LAN (not shown), or a combination thereof.

The log processor 158 first retrieves or otherwise acquires one or more surf history logs 152 for purposes of determining post-search user behavior. The surf behavior log processor 158 in the preferred embodiment redacts ISP and customer privacy identifiers, inspects the logs for records of searches invoked by users-including webpages accessed, and the query terms and like user input submitted to the web servers—and extracts the associated post-search user behavior information. The post-search user behavior information may then be quantified in the form of relevancy metrics and the metrics subsequently recorded in the form of a relational database that associates the search query with (1) the resources accessed and (2) the relevancy metrics derived from the post-search user behavior information. Using this relevancy metric or surf behavior attribute database, the resources listed is a result page may be ranked with maximal relevancy.

When a log entry is discovered showing a search engine website is accessed and a search invoked, the log processor 158 extracts the search terms and subsequent actions taken by the user including, but not limited to: (1) websites and webpages visited by user; (2) the length of the names of those domains visited, preferably the character count; (3) the domain compositions, preferably the numeric and number of numeric characters; (4) the domain hyphens, preferably the hyphen count; (5) the top level domain, preferably distinguishing between .gov, .edu, .com and the like; (6) the country domain, particularly distinguishing between .ca, .uk, .au and the like; (7) the average time spent at a domain, at a subdomain and at a page, for example; (8) the number of actions completed at a domain, at a subdomain, and at a page for example; and (9) the geographic location of the user derived from an IP address, for example.

The post-search user behavior of the plurality of users—including ISP users and users having a tracking module—may then be aggregated to generate a statistically significant representation of post-search behavior including the frequency with which particular webpages are accessed in response to a given query, the average time spent viewing those pages, and the likelihood a transaction will be conducted at those websites, which together form a comprehensive representation of website popularity and the likelihood of the user achieving satisfactory results at those websites.

Referring to FIG. 5 and FIG. 3 together, the log processor 158 in the exemplary embodiment inspects each log including one or more ISP logs 510 (e.g., ISP history log 300), all user logs 512, and UB search engine log 516 as needed. In the process, the log processor 158 identifies each user session therein, redacts the privacy information that could be used to identify users, parses the data as needed, identifies searches 526 and post-search behavior 524, and creates the attribute database from the identified searches and post-search behavior. A session generally starts when the user logs into the ISP system with a user name and password, for example, and ends when the user logs out.

As illustrated, a user “19267” associated with a session “843” conducted multiple searches and accessed several webpages as shown by the rows 312-316 of data in the history log 300. In particular, the log 300 indicates that the user requested the “www.search-engine-1.com” webpage 312 and initiated a search at the first search engine by entering the “song+lyrics” query term 340 as shown in the second row 314. A file containing search results, referred to herein as a search results page with a list of hyperlinks to relevant search results, is returned to the user. Using the returned results list, the user clicks on a URL associated with the “www.song-lyrics-site-1.com/showsong.php?” webpage, as shown in the third row 316. In response, the log processor 158 may record the terms of the query, the fact that the user viewed the URL “www.song-lyric-site-1.com/showsong.php,” and the time spent viewing the one or more webpage at that site.

The user then initiates another search at a second search engine site at “www.search-engine-2.com” using the same query term 344, as shown in the fourth row 318. The user clicks on the “www.song-lyrics-site-2.com” link to request the associated page as shown in the fifth row 320. The log processor 158 identifies the terms of the second query at the second search engine, the website visited thereafter, and the time spent viewing “www.song-lyrics-site-2.com.”

The user then refines the original search using the query “country+song+lyrics” 346, as shown in the sixth row 322. Based on the resulting search results page, it can be seen that the user accessed several webpages as shown in the group of rows, seven through twelve 324. The user also downloaded a file as shown in the last row 326. In response, the log processor 158 identifies the terms of the refined query at the second search engine, the URL “www.song-lyrics-site-3.com” viewed by the user in response to the query, the time spent viewing the www.song-lyrics-site-3.com and webpages linked to the website, and actions taken by the user at the website including the act of downloading or purchasing files or music.

The ISP surf history log may also capture various popularity information 526, such as, the frequency a web page has been viewed by various users, for example, within a certain period, the frequency of page views a certain subdomain within a website has been viewed, the frequency a certain file has been downloaded and by how many users, the number of users accessing a particular web site within a certain time period, and the like. In some embodiment of the invention, log processor 158 filters or otherwise omits particular records from the history logs that are not relevant to the ranking process discussed below. Pages accessed for less than half a second, for example, are presumed to have been clicked on erroneously and are therefore redacted or otherwise ignored by the log processor 158. The URLs associated with search engines may also be redacted after the queries are identified since the number of times a particular search engine is accessed is typically not relevant to the ranking process.

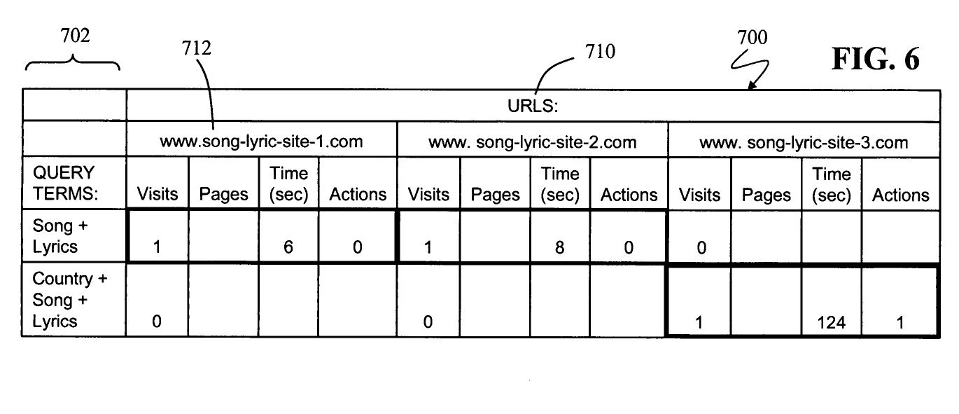

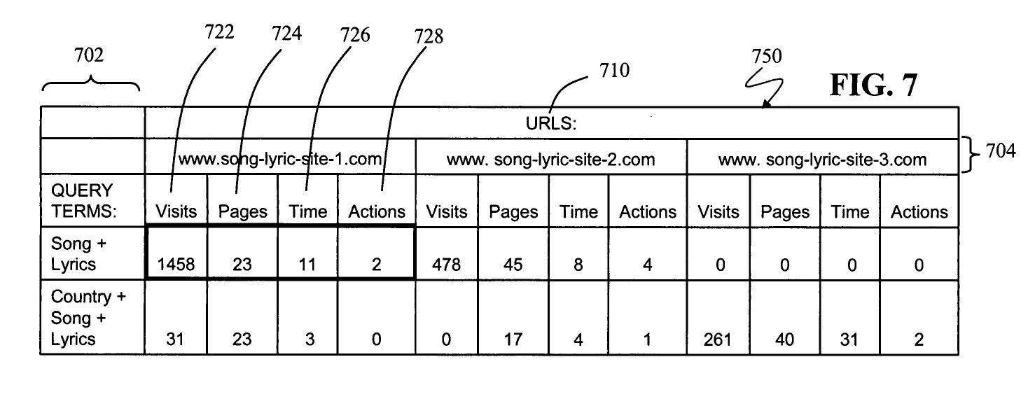

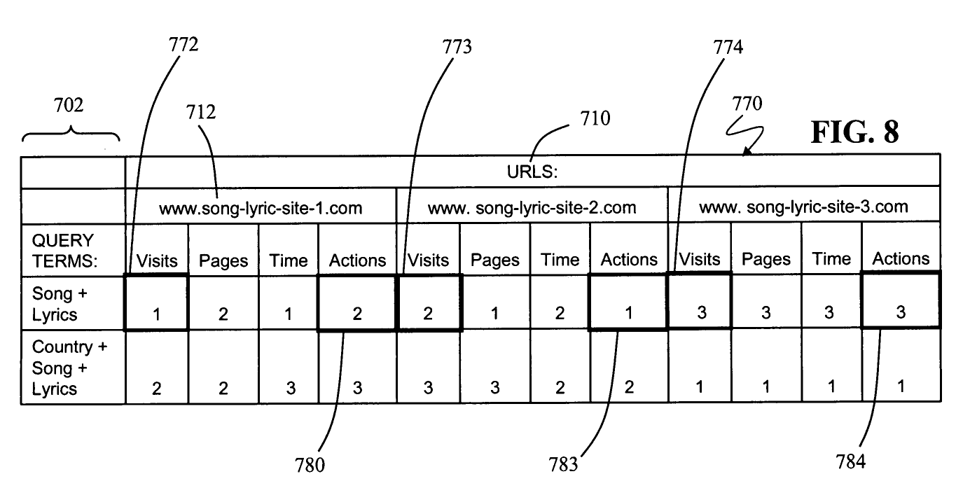

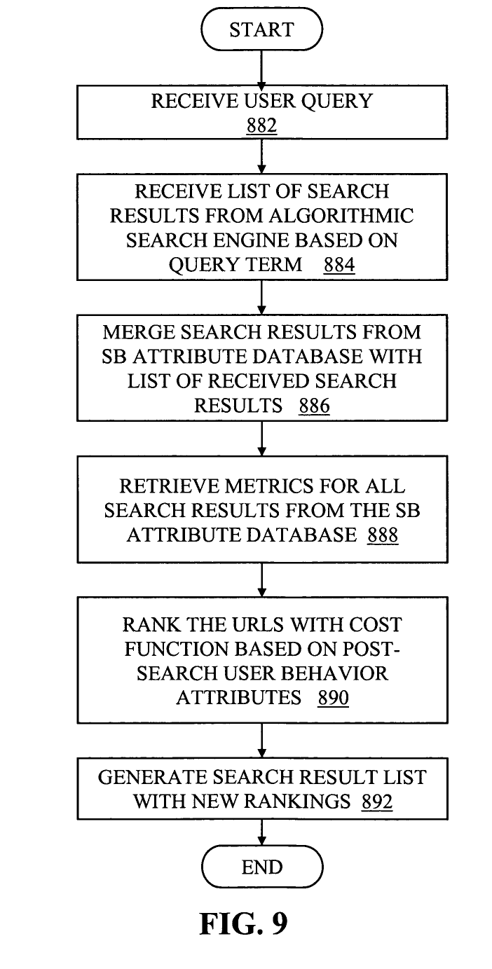

The surf behavior of the user “19267” can be summarized in the individual user SB database of FIG. 6. As can be seen, the user made a single visit to “www.song-lyrics-site-1.com” for approximately six seconds and a single visit to “www.song-lyrics-site-2.com” subsequent to the queries for “song+lyrics.” Thereafter, the user spent approximately two minutes (124 sec) viewing multiple webpages at “www.song-lyrics-site-3.com” after refining the search to further include the term “country.”

Illustrated in FIG. 7 is an exemplary comprehensive SB attribute database 142 compiled by the log processor 158 of the preferred embodiment from the surf histories of many users. Although the table illustrated includes only two queries and three URLs, this attribute database 142 generally contains (1) a comprehensive list of unique queries submitted by users to various search engine websites, (2) a comprehensive list of resources—preferably URLs to webpages and documents—determined to be relevant to one or more queries based on post-search user behavior, and (3) the metrics characterizing the relevancy of an associated URL recited above to an associated query recited at the left.

The list of queries is indicated in column 702 and the list of URLs 710 is indicated in the top row 704 beginning with the domain name “www.song-lyric-site-1.com” 712. At the intersection of each query and URL is a vector 720 including one or more metrics indicating the expected relevance of the URL to the associated query. The vector 720 in the preferred embodiment comprises four metrics including the site and pages visited, the URL dwell time, and actions taken at those sites. In particular, the first metric 722 indicates the number of times the associated website was visited or document viewed within a determined period of time, the second metric 724 indicates the number of underlying webpages linked or otherwise reachable through to the website indicated by the associated URL, the third metric 726 provides a measure of time that the webpage indicated by the URL and its associated child webpages, and the four metric 728 indicates the number of actions taken while at the webpage indicated by the URL and its associated underlying webpages. Actions may be defined to be any set of one or more transactions including, for example, the downloading of a file, the submission of an order, or other financial transaction.

In general, a URL is considered more relevant the more frequently it is visited by users, the more underlying webpages or other subsidiary links it possess, the longer users spend viewing those pages, and the more actions are taken at the website. Referring to the first query for “song+lyrics” in FIG. 7, it can be seen that www.song-lyric-site-1.com has been visited by more people than www.song-lyric-site-2.com (1458 visits verses 478 visits), viewed on average for longer periods of time by those people (11 seconds verses 4 seconds), although it resulted in a fewer number of downloads or other transactions by those people (2 action verses 4 actions). The third website www.song-lyric-site-2.com, in contrast, was not visited at all by those users executing the same query. Therefore, the “www.song-lyric-site-1.com” is generally a more relevant site than “www.song-lyric-site-2.com” for those searching “song+lyrics,” although the site “www.song-lyric-site-3.com” is generally more relevant to a search for “country+song+lyrics” than either of the preceding two sites.

The surf behavior attribute database 142 is preferably stored in a relational database for easy access and storage. The surf behavior attribute database 142 may also be compiled directly from one or more history logs, indirectly using a plurality of individual user SB database as shown in FIG. 6, or a combination thereof. One skilled in the art will appreciate that it may be necessary to eliminate duplicate URLs or associated attributes where, for example, the log processor 158 integrates history logs from an ISP together with the history logs of the individual clients of the ISP, which might otherwise result in double counting if not accounted for. Similarly, if URLs relevant to a query are identified and integrated with the search results list from one or more algorithmic search engines or databases, it may be necessary to federate—i.e., remove duplicate or redundant URLs—when combining the results from the different sources.

Once the surf behavior attribute database 142 has been compiled, the UB search engine uses the attributes to refine the ranking of the search result listing provided by one or more sources schematically represented by the search result listing 144 of FIG. 1D. The search result listing 144, which has a default ranking determined by the algorithmic search engine 170, is re-ranked by evaluating an optimization function such as a multi-variable cost function for each of the search results and re-ranking those results based on the relative value of the cost function.

An exemplary ranking cost function is the weighted linear combination shown in equation [1] below. The cost function, J, is preferably a function of the four metrics: the original search engine rank, R; the number of child pages reachable through a URL, P; the average time, i.e., the dwell time, spent by users viewing the webpages, T; and the number of actions taken by users through the webpages, A. In this exemplary cost function, J, Wt(i) is the weight for a particular variable, i, and Ei is the power to which the particular variable is raised.
J=W₁×R^{E1}+W₂×P^{E2}+W₃×T^{E3}+W₄×A^{E4} [1]

were W₁, W₂, W₃, and W₄ are weights and E1, E2, E3, and E4 are exponents indicating the power to which the associated metric is raised. In one implementation, the weights are: W₁=40%, W₂=20%, W₃=20%, and W₄=10%; and the exponents E1 through E4 are all set to unity.

The cost function may be expanded with additional terms as needed to make the ranking dependent on additional factors including for example: the original ranking of search results from additional search engines, the paid rank associated with one or more algorithmic search engines, the average number of times a query term appears in the resource being ranked, the average number of times subdomain pages or underlying pages under a splash page are viewed subsequent to a query, the average number of subdomain clicks; and the expected revenue to be attained for a click-through.

The set of weights and exponents are selected to increase the rank of the search results that are most relevant to user queries, i.e., the relevant results are placed highest in the search result page. The value of the weights and exponents are determined in the preferred embodiment by matching the rank of a set of sample search results used for training with the ranking subjectively determine by a human editor for the same set of sample search results. The sample search results are generally associated with one or more queries, e.g., the two queries 702 of FIG. 7. In the preferred embodiment, human editors first assigned a rank to each search result of a set of sample search results derived, for example, from the algorithmic search engine 170. The human editor ranks the results from the most relevant to least relevant. The four weights and four exponents are then determined such that—when used to generate the cost function for each of sample search results—the sample search results have the same or most similar ranking as that determined by the human editor. The weights and exponents may then be applied to evaluate the cost functions used to rank subsequent search results associated with the same or similar queries.

For example, the weights W₁ through W₄ and exponents E1 through E4 may be determined such that the three or more URLs—including “www.song-lyric-site-1.com,” www.song-lyric-site-2.com,” and “www.song-lyric-site-3.com” from FIGS. 6 and 7B—are ranked in the same order of relevance as that provided by a human editor, ands the weights and exponents used thereafter to rank subsequent search results from the algorithmic search engine for related queries including “song+lyrics” and “country+song+lyrics.”

The process of selecting the appropriate weights and exponents may be solved using a number of optimization techniques known to those skilled in the art including genetic algorithms and least squares fit, for example. The weights and exponents may be initially determined for a plurality of search topics and periodically updated to reflect changes in the content and popularity of websites as well as various forms of feedback. Feedback may be derived from the PSUB information. If for example it is determined from the history logs that relatively few users click through to visit a URL with a prominent position in the search results because of particular metric, the weight and exponent associated with the particular metric may be adjusted to reduce its contribution to the cost function, thereby lowering the placement of the URL in the search results pages after it is re-ranked by the UB search engine 140.

In some embodiments weights W₁ through W₄ and exponents E1 through E4 may be determined after the metrics are effectively “ordered” based on hierarchy as opposed to the actual metrics specifically. As illustrated in FIG. 8, each of the metrics in the attribute database 770 is replaced with an “ordered metric” ranging from 1 to N, N being the number of URLs subjected to the ranking process at the UB search engine. The ordered metrics are assigned based on the relevance of the associated URL relative to the other URLs associated with a particular search query. The most relevant URL with respect to a particular metric is assigned a value of “1” while the least relevant URL is assigned a value of “N.” With respect to the “visits” metric and the query “song+lyrics,” “www.song-lyric-site-1.com” is assigned an ordered metric 772 of “1” because in was visited most frequently (1458 visits), “www.song-lyric-site-1.com” is assigned an ordered metric 773 of “2” because in was visited less frequently (478 visits), and “www.song-lyric-site-3.com” is assigned an ordered metric 774 of “3” because in was visited least frequently (0 visits). Similarly, with respect to the “actions” metric and the query “song+lyrics,” “www.song-lyric-site-1.com” is assigned an ordered metric 780 of “2” because a moderate number of actions were taken at the site (2 actions), “www.song-lyric-site-2.com” is assigned an ordered metric 783 of “1” because it was the site of the most actions (4 actions), and “www.song-lyric-site-3.com” is assigned an ordered metric 784 of “3”, because it was the site of the least actions (0 actions). When metric ordering is employed, the weights and exponents are determined in the same manner as that described above. Thereafter, the metrics, weights, and exponents may be used to re-rank search results to improve the relevancy of the search results and better match the intent of the users.

Illustrated in FIG. 8 is a high-level flow chart showing the method by which the UB search engine, particularly the search processor 160, generates and re-ranks a search result listing in accordance with an embodiment of the invention. In the first step, the search processor 160 receives (step 882) a query including one or more terms from a user. The search processor 160 then retrieves (step 884) a list of a plurality of search results associated with the received query from one or more sources of algorithmic search results, e.g., algorithmic search index 172. The search processor 160 may optionally retrieve search results from the SB attribute database 142 and merge (step 886) those results with the list from the algorithmic search index 172, which may require federation to remove duplicate URLS. Once a set of search results is obtained, the search processor 160 retrieves (step 888) from the attribute database 142 the one or more ordered metrics that characterize each of the URLs recited in the set of search results. The search processor 160 then ranks (step 890) (i.e., re-ranks) each of the URLS based on the associated metrics from the SB attribute database 142, which in the preferred embodiment entails evaluating a cost function for each URL based on the associated ordered metric and the weights and exponents predetermined in the manner described above. Using the value of the cost function associated with each URL, the set of search results are order from the most relevant to the least relevant and a search results page generated (step 892) for the user. In an alternative embodiment, the search processor constrains the use of the PSUB search attributes to only those of a select user segment. Determination of the segment that is appropriate for a given user may either be thru an opt-in process, such that the user declares the segment they are a member of or interested in, or thru conventional collaborative filtering methods.

User Intention Search Results Page Types

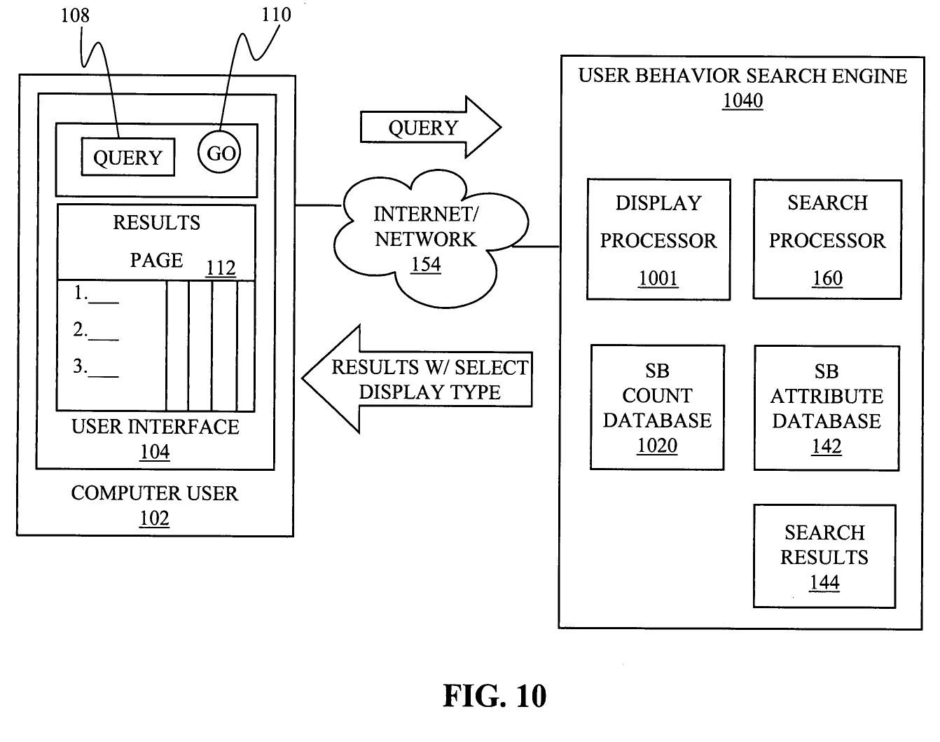

Illustrated in FIG. 10 is a functional block diagram of a network including a UB search engine 1040 further including a display processor module 1001 and a surf behavior count database 1020. The display processor 1001 is generally adapted to select one of a plurality of page display types with which to present search results to the user based on statistical profiles of prior search behavior maintained in the SB count database 1020. The UB search engine 140 retrieves and ranks search results in a manner consistent with FIG. 1, the difference being that the search engine uses one of a plurality of select formatting types to display the search results depending on the anticipated intent of the user as determined by the search engines use of PSUB information.

In a preferred embodiment, there are at least two and preferably four display types from which the UB search engine 1040 may select, each tailored to present results to a user in a manner to rank relevant results highest. The four display types preferably include (a) navigation display page type, (b) a product-search display page type, (c) a cluster display page type, and (d) a general display page type.

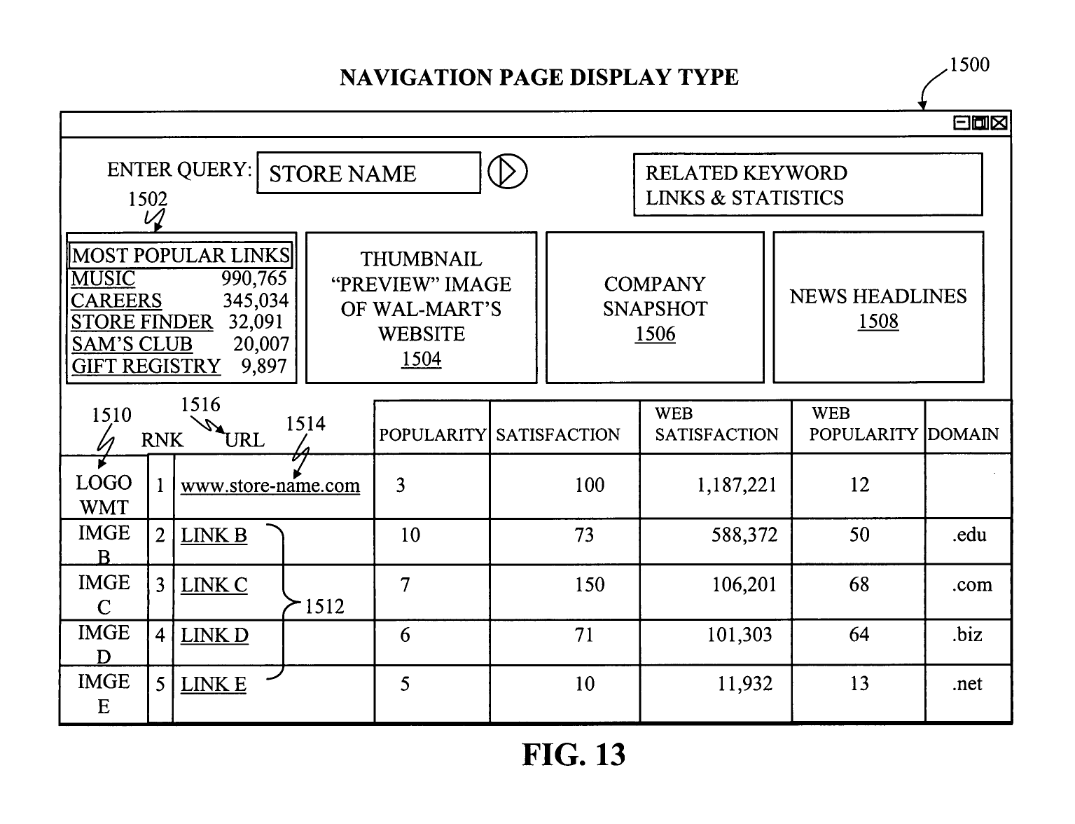

The Navigation display page type is selected when the user intends to navigate to a specific URL. If the user query includes, for example, a specific store name or brand name, it is inferred that the user intends to navigate to the website of a specific store. In this case, the search results provided to the user include the URL targeted by the user at the top and most prominent position in the listing, as illustrated in FIG. 13 discussed in more detail below.

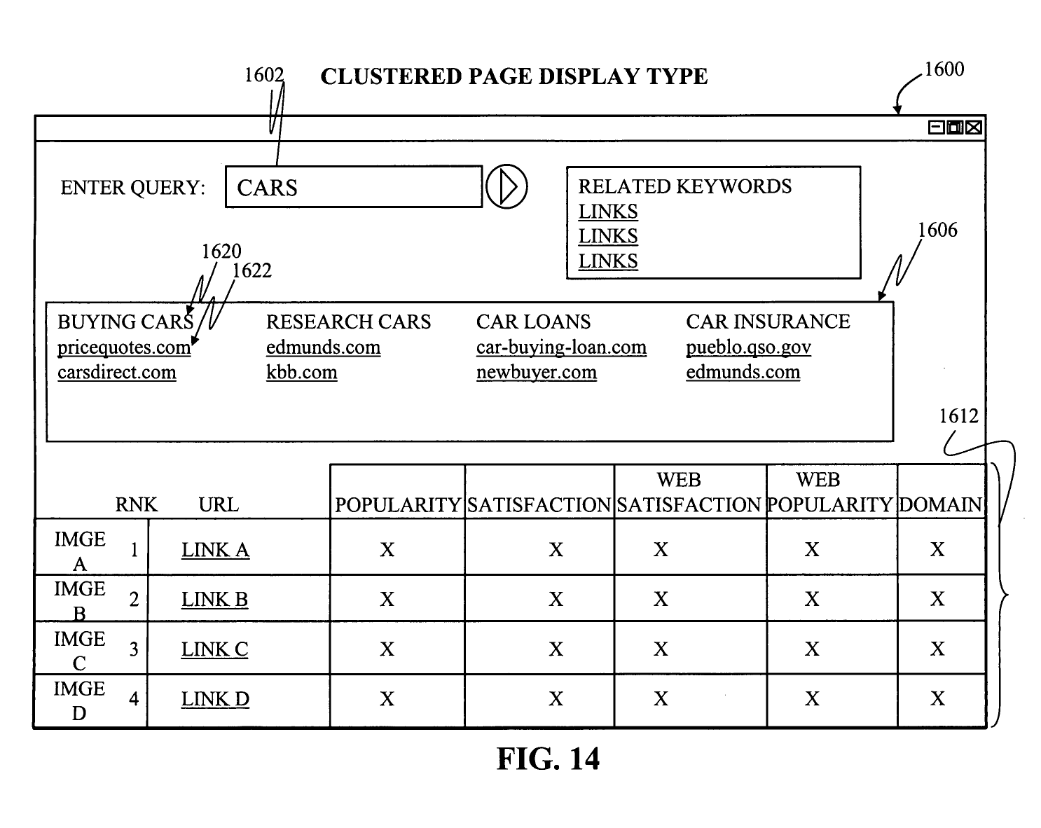

The Cluster display page type is selected when the user's intention cannot be fully determined by the query alone, e.g., the query is ambiguous. In this case, two or more broad categories of intent are identified and displayed in an effort to assist in resolving the user's intent. As illustrated in FIG. 14, a query for “cars” may ambiguously refer to a query regarding the purchase of a car, car research, car loans, or car insurance, for example.

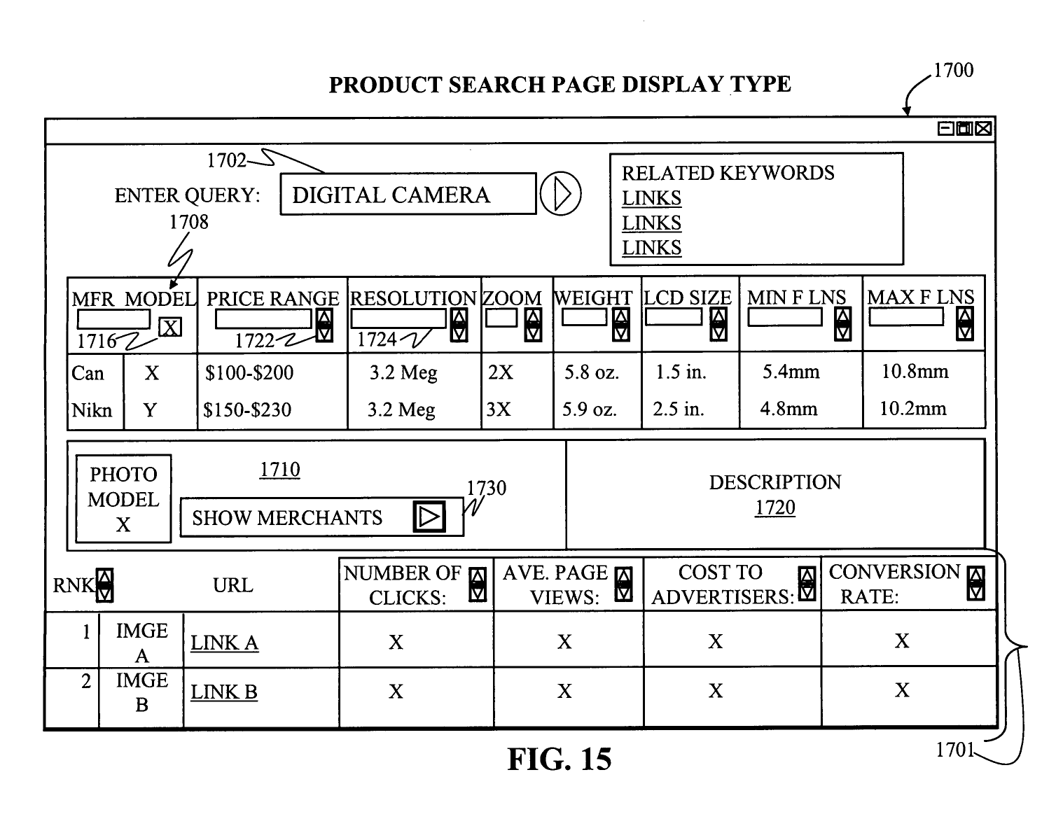

The Product Search display page type is selected when it is apparent that the user intended to shop for a specific item or service, in which case the search results are tailored to present the user with one or more categories of products related to the item or service searched. As illustrated in FIGS. 15 to 17, the response to a query including the phrase “digital camera” may comprise the URLs of one or more merchants selling digital cameras as well as a product selection tool including a plurality of predetermined categories of digital cameras with which the user can opt to narrow the search.

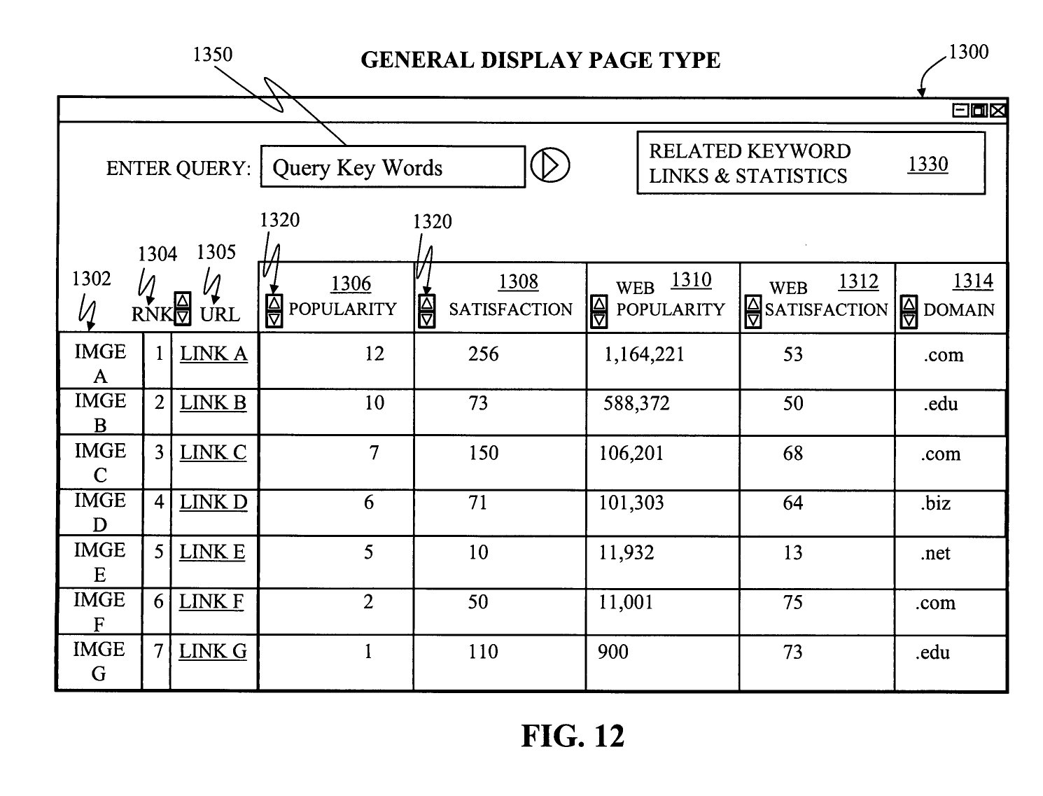

The General Search display page type illustrated in FIG. 12 is selected when user intent cannot be categorized in one or the preceding categories based upon the specific query.

The display page type that is selected and transmitted to the user for display of the search results is generally dependent on the terms of a user's query and one or more counts associated with the post-search user behavior of prior users including the number of prior user click-throughs, although it may also be determined based on one or more interactive buttons pressed, one or more hyperlink clicks, or a combination thereof.

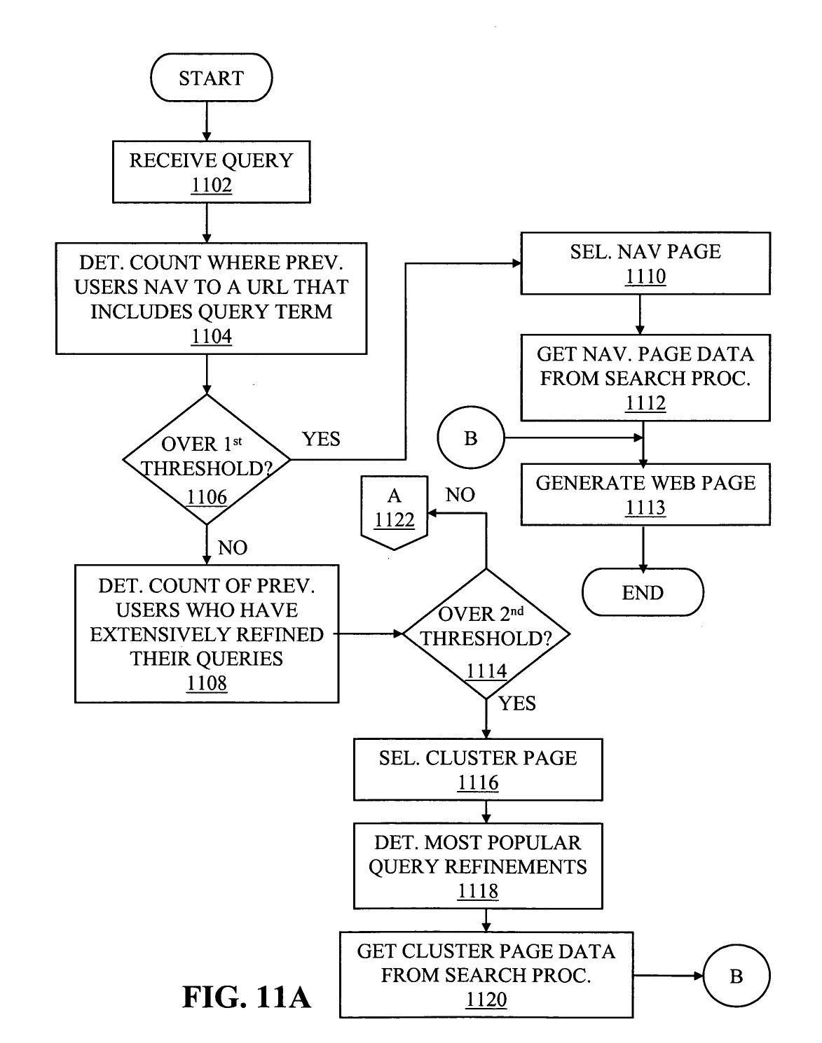

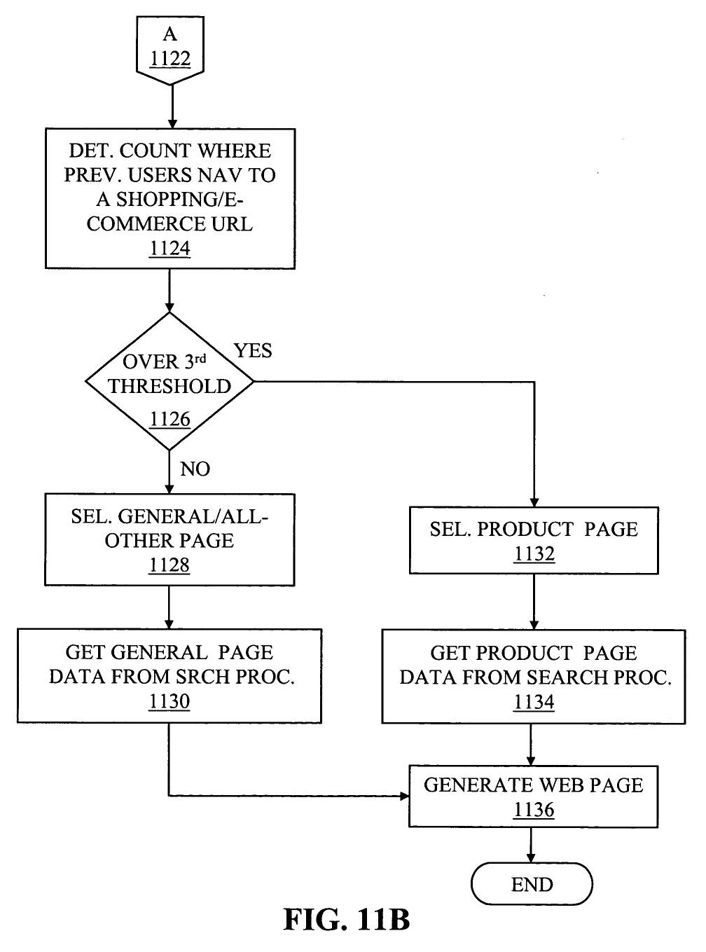

Illustrated in FIGS. 11A and 11B together is a high-level flow chart of an exemplary method of selecting the appropriate page type with which to display search results to a user. Once a search query has been received (step 1102), the UB search engine 1040 in one embodiment retrieves an associated count—referred to herein as a navigation count—from the SB count database 1020. The navigation count is a measure of the number of prior users that have clicked on or clicked through a particular URL immediately after conducting the same query. A strong correlation between a particular query and an associated URL is an indication that most users intend to navigate directly to the URL. The navigation count is one of a plurality of counts maintained in the SB count database 1020, each of the plurality of navigation counts being associated with one query and the URL visited most frequently subsequent to the query.

The navigation count as well as the other counts discussed below may be a cumulative number representing the total number of click-throughs observed, or the number of click-throughs observed for a determined number of related searches, i.e., a percentage of click-throughs to the associated URL when provided in response to the same query.

If this navigation count exceeds a first user-defined threshold (step 1106), the display processor selects (step 1101), retrieves (step 1112) the particular URL to which the user intended to navigate and other relevant search results from the algorithmic search engine, for example, and generates (step 1113) the search result page in accordance with the navigation page for the user. The particular URL is placed at the top of the results list where it is more prominent. The particular URL is generally the website having the highest click-through frequency for the same or similar query.

If the navigation count, however, does not satisfy the first user-defined threshold, the display processor 1040 retrieves (1108) a second count-referred to herein as a search refinement count-indicating the number of users who have submitted the same query and subsequently refined the query. It may be necessary to refine a query where the intent behind the original query cannot be discerned because the original query is, for example, vague or ambiguous. There is a search refinement count in the SB count database 1020 for each of the most popular search queries.

If the search refinement count exceeds a second user-defined threshold, the display processor 1001 selects the clustered page type (step 1116), determines the one or more popular query refinements (step 1118), obtains data including search results relevant to the one or more most popular query refinements from the search processor 160, populates the cluster page (step 1120), and generates the resulting webpage then sent to the user. The search results relevant to the one or more most popular query refinements may include unpaid search results as well as paid listing, for example, whose rank is determined with the cost function using the attributes, weights, and exponents associated with the most probable query refinements as opposed to the ambiguous query.

If the search refinement count fails to satisfy the second user-defined threshold, the display processor 1001 determines whether to apply a product search display page type based on the number of users who have navigated to a shopping-related website (step 1124) subsequent to the same query. The determination in the preferred embodiment is based at least in part on a comparison of a count—referred to herein a shopper count—with a third user-defined threshold. The shopper count, is one of a plurality of counts maintained in the SB count database 1040, each of the plurality of shopper counts used to track the frequency with which users click through to a shopping-related URL after performing a particular query. A strong correlation between a query and a shopping-related website is an indication that most users executing the query intend, for example, to browse and or purchase goods or services.

As one skilled in the art will appreciate, the first, second and third user-defined thresholds may be selected and periodically adjusted to best match the page display type to the user intent as determined by the relevancy determination discussed above.

Referring to FIG. 11B, if the shopper count exceeds the third user-defined threshold, the display processor 1001 selects the product page type (step 1132), obtains data including search results from the search processor (step 1134) to populate the product page (step 1112), and generates the resulting webpage (step 1136) formatted in accordance with the product page display type. If the shopper count, however, fails to exceed the third user-defined threshold, the general or all-other display page type (step 1128) is selected and data to populate such page is obtained from the search processor (step 1130) to generate the appropriate web page (step 1136).

General Display Type

Illustrated in FIG. 12 is an exemplary search result page 1300 formatted in accordance with the general display type of the preferred embodiment. The results page 1300 in this embodiment comprises a listing of search results in column 1305, each individual result being presented to the user in the form of a plurality of URL hyperlinks schematically represented by LINK_A through LINK_G. In the preferred embodiment, there is an image and rank number presented next to each of the search result links, as illustrated in columns 1302 and column 1304 respectively. The rank 1304 of the results 1305 is preferably determined by their relevance to the query as determined by the UB search engine 1040 and search processor 160 discussed above. The images 1302 are preferably company logo associated with the URL 1305 provided. In addition to a URL link, the column 1305 may further include a summary, excerpt, or brief description of the associated webpage or other resource indicated by the URL.

In some embodiments, one or more statistics characterizing a search result are presented in proximity to the results to help users personally evaluate the potential relevance of the results based prior user behavior. In the preferred embodiment, the statistics presented include (1) a popularity statistic in a first column 1306 indicating the number of users that visited the associated URL or subdomain based on the same or similar query; (2) a satisfaction statistic in a second column 1308 indicating number of times actions are taken at the URL or subdomain, where action may be defined to include downloads or financial transactions, for example; (3) a web popularity statistic in a third column 1310 indicating the overall popularity of the domain by prior users for all queries; and (4) a web satisfaction statistic in a fourth column 1312 indicating the number of times actions are taken at the URL or subdomain by prior users independent of the query. The top-level domain name is shown in the last column 1314. The values displayed in the several columns 1306, 1308, 1310, 1312 may be maintained by the search processor 160 and retrieved from the surf behavior attribute database 142, for example. In this embodiment, the candidate files, including URLs, are displayed based on the popularity column 1306. The various columns may be sorted and filtered by the user, if desired, by providing appropriate clickable buttons, symbols, or graphics, e.g., sort ascending and descending arrows 1320. This would provide users more control of their display screen. The general display type in some embodiments of the present invention may further include advertising content with hyperlinks such as banners, images, and logos 1330.

Navigation Display Type—User Intent to Navigate to a Specific URL

Illustrated in FIG. 13 is an exemplary search result page 1500 formatted in accordance with the Navigation Display type. The navigation display page 1500 preferably includes: a preview link 1504 and search result link 1514 to the webpage to which the user intends to navigate; the logo 1510 of the site 1514; a thumbnail “preview” image 1504 (or image of reduced resolution) of the site 1514; data about the site or company 1506 to which the user intends to navigate, the data preferably including the year founded or number of employees; stock ticker symbol, daily trade information and visual stock trading chart; and current and past news headlines 1508 regarding the site or company. Users can easily continue on to their destination by clicking one of a plurality of links 1502 to webpages most popular with prior users submitting the same or similar query.

If a user queries “WAL-MART,” For example, the UB search engine 140 queries its database, particularly the surf behavior counts database 1020, to find the number of occasions in which users have navigated to a particular URL that includes the term “WAL-MART.” If this number is greater than a threshold, the user is preferably presented with a Navigation page 1300. This Navigation page 1500 includes information specific to the website, e.g., located at http://www.walmart.com. Preferably, the operator of the UB search engine 140 establishes and tunes the threshold. In addition, preferably the threshold is set by the previous threshold variable percent established by type characterization quantizations. The present invention thus, preferably determines the frequency of behaviorally-attributable results as provided by the UB search engine and if those associated with navigation are the most frequent, then the Navigation type is presented to the searcher.

Cluster Display Type—Multiple Broad Categories

Illustrated in FIG. 14 is an exemplary search result page 1600 formatted in accordance with the Cluster Display type. The clustered page 1600 address potential ambiguity of a query by identifying one or more subcategories of user intent and display search results relevant to each of the subcategories. The query “cars” 1602, for example, is broad and includes related subcategories such as “buying cars,” “research cars,” and “car loans” 1606. In such as case, the search results 1612 are present together with a plurality of subcategory clusters 1620, each of the clusters being associated with one of the possible subcategories of search that prior users have visited subsequent to the same query or more refined versions of the same query. Each of the plurality of clusters preferably includes a subcategory heading, e.g., “buying cars”1620, and one or more URLs 1622 to websites associated with the subcategory, e.g., “pricequotes.com.” Each of the clusters may also include general content about the cluster, links to Internet sites relevant to the cluster, and a link by which the user can execute a new search that is narrower in scope than the previous one. The user can therefore interact with the clusters as described above, or select websites from the list of more general list of search results 1612. In this embodiment, the general search results 1612 are shown in combination with a number of columns consistent in appearance and function to the columns 1306, 1308, 1310, 1312, 1314 of the result page illustrated in FIG. 12.

One way to determine if the cluster form of search result is appropriate is by determining the number of prior Internet users who have extensively refined their queries to find their intended results. The most popular refinements where users found satisfactory results would typically comprise the “clusters” presented to the user. The search engine results optimized by the UB search engine 140 preferably provide a maintained database of original queries and refinements, and actions taken after refinements. This database may include various information such as original query terms, query refinements, related key terms, and the number of persons who have conducted searches using such related key terms. Actions taken after the refinements include actions taken after terminating the search, for example, clicking on a search result and continuing to review website pages, downloading files and even conducting an e-commerce transaction.

The example Clustered page 1600 shown is a result of the user searching for “cars” 1602. The UB Search Engine 140 of the present invention queries its database for this query term and finds the number of occasions where the searchers have refined their queries. Preferably, if the number of such occasions is greater than a threshold, for example, the count for the presently preferred page type display, if any, then the user is presented a “cluster page” containing the most common refined terms where previous searchers have found success, as defined by the above example metrics, and the most popular websites visited for those previous users after refining their query.

Product Search Display Type—User Intent to Shop

Illustrated in FIG. 15 is an exemplary search result page 1700 formatted in accordance with the Product Search Display type. The Product Search page 1700 is generally displayed for purposes of providing a with the means to browse products in a specific category, narrow down the list of products by attributes important to them, determine the current price range in which the products are being sold, see a list of merchants currently selling the product, and finally link to the merchant's site of their choice to complete the purchase.

Described in action or by process of use, when a user searches for a specific type of product like “digital camera,” 1702 several models of digital camera are displayed uniquely with product specification—price range, resolution, zoom, weight, LCD size, etc. At this point the user may either look through the list as it is rendered, choose to sort and/or filter this list of products using sorting buttons 1722 (for arranging results in order of cost, for example) or filter input box 1724 to help decide which most closely meets their needs. Underneath the column of each product specification, for example, an input box or any user interface may be added to enable user, for example, to refine or sort their search. For example, entering “X” 1516 under the “MODEL” category 1708 indicates that the user would like to refine the search to those digital cameras with model “X.”

Products accessible by and included in the Product Search page are those with ‘structured data’—meaning attributes that can be parameterized and managed via a web front end. In the case of digital cameras, these are such attributes as Price Range, Resolution, Weight, Lens size, Focal length, Color, LCD Size, etc. The user can use any of these parameters to reduce the list based on their needs and effectively eliminate all models in which they are not interested.

After selecting a model, the list of merchants selling the product is displayed in a display area 1710, 1720, preferably with a picture, description, and a “SHOW MERCHANTS”1730 link. This display area may include the following: a logo of the merchant; the name and website address of the merchant; a current price of the product; customer rating of the merchant; and a count of the number of times users of the search engine have “clicked-through” to the destination merchant. The user can interact with the product and merchant data as described above, or use a list of search results contained on the lower half of the page to see listings relative to the search query used.

In order to determine the appropriateness of the Product Search form of search result, preferably, the results of the UB search engine 140 having listing optimization functions based on search behavior determines that prior Internet searchers have navigated to a known comparison shopping engine or e-commerce website after making the same, or similar, query. For example, if a user queries “digital camera,” preferably the search engine queries its database for a query and find the number of occasions, where previous searchers navigated to a URL from a domain of a known comparison shopping service. If such occasions are greater than a threshold, the user is presented a product search page form 1700 for that query as illustrated by the example in FIG. 15. Preferably, the operator of the search engine having listing optimization functionality based on user search behavior establishes and tunes the threshold, similar to fine-tuning mechanism of the various forms of pages. Alternatively, a query term is associated with a product page display type and such association stored in a database based on data gathered, for example, from the surf behavior attribute database and/or human editors.

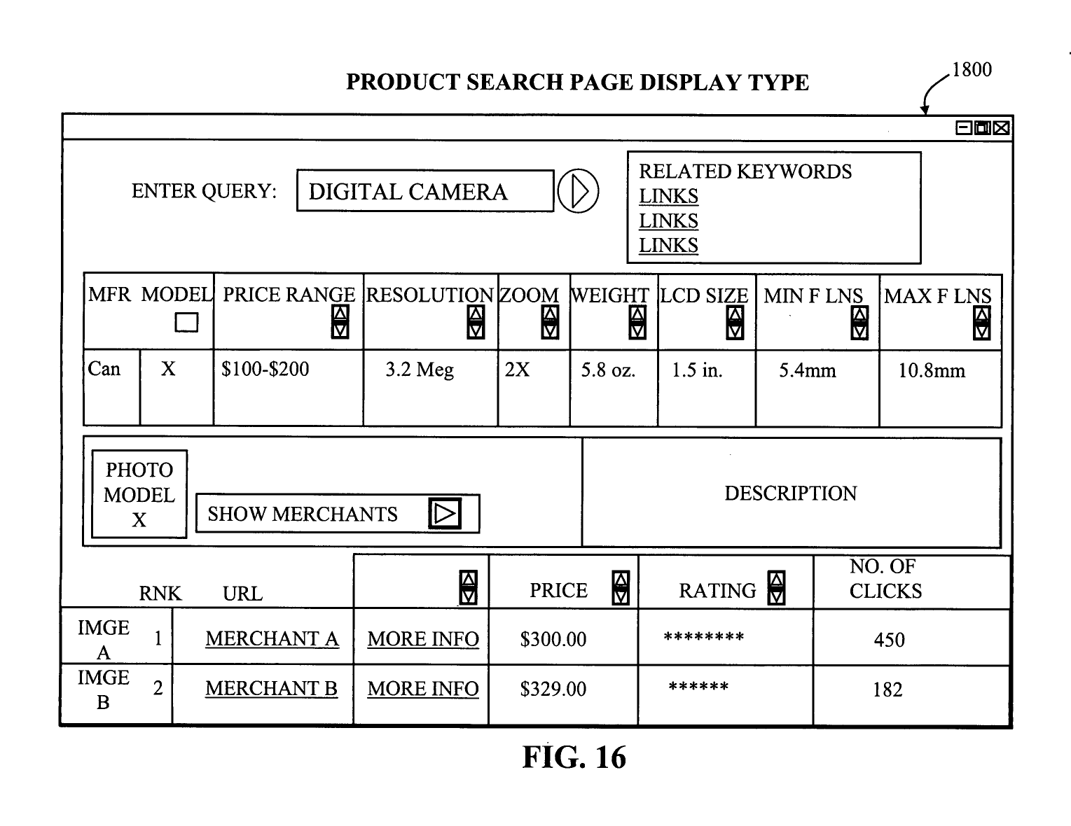

FIG. 16 illustrates exemplary search results, particularly filtered results, where the user has entered alphanumeric information—in this example, the model of the camera “X”—to refine and narrow his or her search. This embodiment of a product search page 1800 also includes a shopping link, “Show Merchants” button 1802. The merchants selling model “X” and comparison-shopping information, such as price and merchant and/or product rating, are shown at the bottom of the page 1850.

In another embodiment, a database tracks completed transactions after a query to identify if a product search page would be appropriate. Synonyms, query expansion and specific product models would also be taken into account in looking up actions and determining the appropriate product shopping search result. For example, terms such as “digital cameras,” “analog cameras,” and “video” may all be considered the same or similar products for determining the applicability of this type of page and may in fact map to a common camera comparison-shopping page. In one embodiment, the database identifies certain query term as product related and thus is associated with the product display type. This may be done with the help of human editors.

Comparison Shop from Search Results

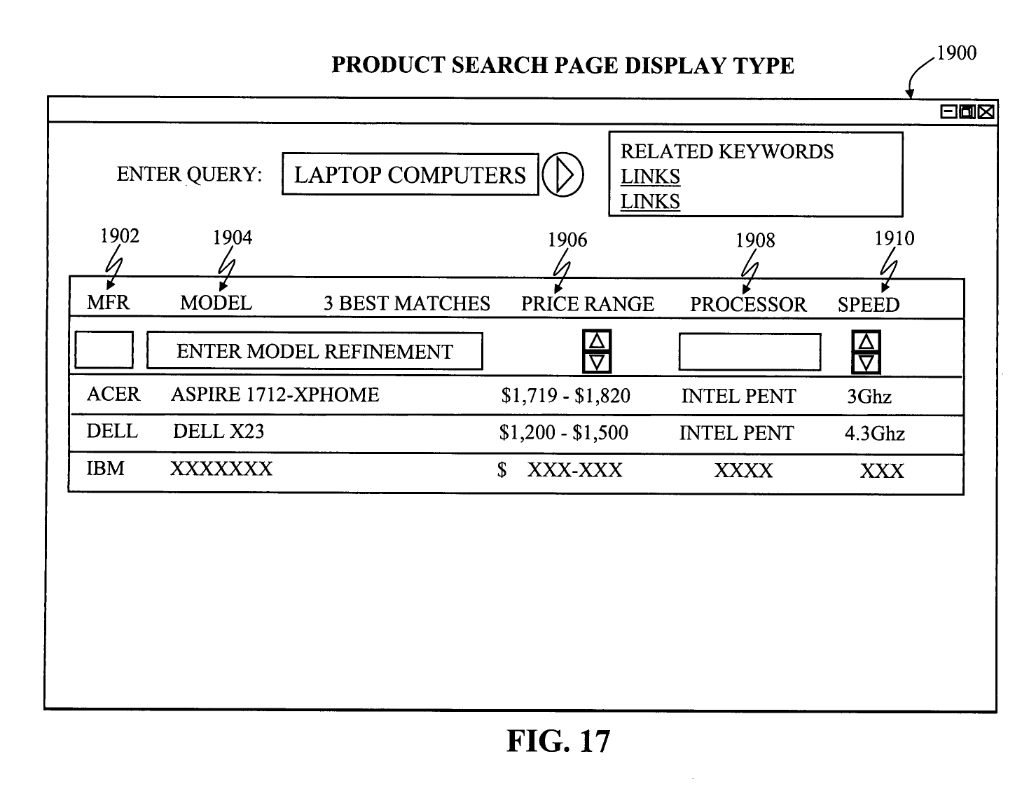

In the situation where the search results are a “product search page” the results may include a hypertext link where the user can click and the results are modified to show merchants offering the product for sale. FIG. 17 illustrates how a user has clicked on a product search page and clicked on a button to activate comparison-shopping directly from their search results.

As one skilled in the art will appreciate, the display type selected used to present search results to users may be selected each time a query is submitted, thereby allowing the UB search engine to dynamically change the results page between the Navigation, Clustered, and Product elements, and/or the general display type as the user changes and or refines the query.

Variations of these types of webpages may be done and still be part of the present invention. In a side bar, for example, advertisers who paid advertising fees may be listed similar to how traditional search engine list their advertisers. Furthermore, variations on the placement of data and how data is presented may be incorporated in the various page types.

Regardless of the type of search results page shown to the user, the embodiments of the invention may present information to the user that includes data based on other Internet users' post-search behavior. Such information may include sites visited, pages viewed, and number of transactions completed at sites. This information may also include the popularity of a site and satisfaction of visitors to that site.

Filtering and Sorting of Search Results

Regardless of the type of search results page shown to the user, the invention presents the search results in a format where the results information is in multiple fields. Typically the fields will be in the form of columns on the user interface. Each of the columns may preferably be sorted and filtered based on the values contained in the column. Sorting organizes the search results relative to one another based upon the information (alpha numeric) in the column. Filtering reduces the number of matching items in the search results.

FIG. 17 is another example of a variation of a products search page 1900. This page shows various parametized information related to a computer laptop product search page. Each column (e.g., manufacturer 1901, model 1904, price range 1906, processor 1908, and speed 18910) may be independently sorted while at the same time filtered on multiple columns. Filtering can include arithmetic operators such as “>,” “<,” and “=.” The user may, as an option, also create a custom column where the values of other columns are used in an arithmetic expression. For instance, using the above columns as an example, an additional user-created column could divide computer screen size by computer weight, which then could be sorted. The filtering and sorting is preferably done on the search engine side rather than at the client's side.

Revenue Based Ranking Criteria

Referring back to FIG. 1, the portal system of some embodiments also includes an advertising engine 194 that enable advertisers to provide paid advertising pricing information and advertising content incorporated into one or more webpages provided to users. The advertising engine 194 preferably enables an advertiser to contact the UB search engine through the Internet, for example, and upload conventional advertisements and set a specific value for one or more of a plurality of different services offered by the UB search engine. These services include, but are not limited to the placement of banner ads on UB search engine webpages presented to users, click-throughs, paid listings incorporated into the search results ranked by the UB search engine, commissions for user purchase, and commissions for any of a number of actions made by a user as a result of a UB search engine listing which is referred to herein as a “conversion,” or a combination thereof. The ad engine 1030 manages the advertising content and tracks the number of advertising events for accounting purposes.

The advertising engine 194 of the present invention is adapted to record the number of impressions created with an advertisement or paid listing, the number of click-throughs to an advertiser website as well as the number of compensable actions undertaken by the user with an advertiser subsequent to the click-through. Actions for which advertisers may pay may include product purchases, file downloads, and lead referrals, for example. The advertising engine 194 may be informed of user actions subsequent to the click-through with the cooperation of advertiser which may be obligated to report such actions or maintain tracking software known to those skilled in the art.

In the preferred embodiment, the search processor 160 is adapted to rank paid listings based in part on the price that an advertiser is willing to pay for the conversion and the average conversion rate—i.e., the average number of conversion actions divided by the number of clicks-throughs to the associated advertise. When made available in the search processor 160 or attribute database 142, the conversion value and projected conversion rate may serve as metrics factored into the cost function when determining a URL's rank in the search result sent to the user. Projected conversion rate may be determined in different manners based on widely used statistical probability models. The product of the conversion value and projected conversion rate may also constitute one of a plurality of metrics for determining the rank of an associated URL, thereby allowing the UB search engine to rank paid listing so as to maximize the relevancy to the user as well as the financial return to the portal system 100. As discussed above, the weight and exponent associated with the conversion value and conversion rate may be periodically adjusted to ensure that users are provided appropriately relevant documents when conducting a search through the search portal system of the present invention.

Although the above description contains many specifics, these should not be construed as limiting the scope of the invention, but rather as merely providing illustrations of some of the presently preferred embodiments of this invention.

Therefore, the invention has been disclosed by way of example and not limitation, and reference should be made to the following claims to determine the scope of the present invention.

What is claimed is:

1. A system for generating ranked search results based on past user behavior, the system comprising:
an attribute database comprising a plurality of queries, a first set of resources associated with each of the queries, and a set of one or more metrics characterizing the relevance of the first set of resources to the plurality of queries; wherein the set of one or more metrics are derived from post-search user behavior of a plurality of prior users; and
a search processor adapted to:
a) receive a query from a user;
b) identify a second set of resources relevant to the received query from the user;
c) retrieve from the attribute database the one or more metrics associated with the received query and each of the second set of resources;
d) rank each of the second set of resources based on the retrieved one or more metrics; and
e) return at least a portion of the second set of resources ranked in accordance the retrieved one or more metrics.

2. The system of claim 1, wherein the first set of resources comprises one or more resource locators.

3. The system of claim 2, wherein the one or more resource locators include at least one Uniform Resource Locator (URL).

4. The system of claim 1, wherein the set of one or more metrics associated with a URL are selected from the group consisting of: the average number of prior user click-throughs from a search result page to the associated URL; the frequency with which the prior users viewed the associated URL; the number of webpages at a domain associated with the URL, the average number of webpages viewed by the prior users at the domain associated with the URL; the average time spent by prior users viewing webpages at the domain associated with the URL; the average number of prior users that downloaded files from the domain associated with the URL; the average number of prior users that executed scripts from the domain associated with the URL; the average number of prior users that placed orders at the domain associated with the URL; the average number of prior users that made purchases at the domain associated with the URL; and the average number of sessions created by prior users.

5. The system of claim 4, wherein the set of one or more metrics are further selected from the group consisting of: URL character length, URL number count, URL hyphen count, top level domain type, country domain.

6. The system of claim 4, wherein the post-search user behavior of the prior users is derived from one or more clickstreams recorded for of each of the prior users.

7. The system of claim 6, wherein at least one of the one or more recorded clickstreams are recorded by one or more Internet surface providers (ISPs) providing Internet access to the prior users.

8. The system of claim 6, wherein at least one of the one or more recorded clickstreams are recorded by a computing device of one or more of the prior users.

9. The system of claim 1, wherein the second set of resources are derived from history logs originating from one of more of a plurality of sources of relevant search results: the set of sources selected from the group consisting of: at least one algorithmic search index, the attribute database, and a combination thereof.

10. The system of claim 1, wherein the search processor is adapted to generated a cost function for each of the resources of the second set of resources.

11. The system of claim 10, wherein the cost function is a least squares algorithm base is part on a ranking of the second set of resources defined by one or more human editors.

12. The system of claim 1, further comprising a display processor adapted to:
select one of a plurality of page display types based at least in part on the received query; and
generate a search result page with ranked search results formatted in accordance with the selected page display type.

14. The system of claim 14, wherein the plurality of page display types comprises a navigation page type.

15. The system of claim 14, wherein the plurality of page display types comprises a cluster page type.

16. The system of claim 14, wherein the plurality of page display types comprises a product page type.

17. The system of claim 14, wherein the plurality of page display types comprises a general page type.
